(19) United States
(12) Patent Application Publication
(10) Pub. No.: US 2005/0220834 A1
(43) Pub. Date: Oct. 6, 2005

(54) Agricultural chemical microemulsion

(76) Inventors: Xiao Du Wang, San Antonio, TX (US); He Du Mi, Alta Loma, CA (US); Zhi Gang Gao, Beijing (CN)

Correspondence Address: JACOBSON HOLMAN PLLC, 400 SEVENTH STREET N.W., SUITE 600, WASHINGTON, DC, 20004, US

(21) Appl. No.: 10/945,314

(22) Filed: Sep. 21, 2004

(30) Foreign Application Priority Data
Mar. 24, 2004 (CN) 200410029556.X

(51) Int. Cl. A01N 25/00

(52) U.S. Cl. 424/405

(57) ABSTRACT

The present invention relates to an agricultural chemical microemulsion comprising agricultural active ingredient and natural high molecular material as efficient synergist and/or toxicity antagon. The present invention also relates to the preparation method of the agricultural chemical microemulsion and the use of the high molecular material as synergist and/or toxicity antagon in agricultural chemical microemulsion. The agricultural chemical microemulsion in the present invention possesses substantial synergistic action and improved safety in use.

### TECHNICAL FIELD

This invention relates to agricultural chemical microemulsion comprising efficient high molecular synergist and/or toxicity antagon (for example fulvic acid etc.), and the use of the high molecular material as synergist and/or toxicity antagon in agricultural chemical microemulsion.

### BACKGROUND OF INVENTION

As the broad use of agricultural chemical, it attracts an increasing attention on how to reduce the environmental pollution and harm to human and livestock. Therefore, the development trend of agricultural chemical is to reduce the toxicity and promote the effect. Formulation development is a quick and economical method to reduce toxicity and promote effect compared to original agricultural chemical development. At present, we are left behind by the advanced countries in agricultural chemical formulation development. The main formulations are the emulsifiable solution and wettable powder whose consumption accounts for 70-80% of total formulation, moreover, the form of prepared chemicals is relatively simple. The proportion of original chemical and formulation is 1:6, while it is 1:30 in developed country. Obviously, the gap is too large. The singleness of agricultural chemical can not adapt to the development of modern agriculture and especially demand for agricultural chemicals arising from the structural adjustment of agricultural product, and influence exceedingly the market promotion and service life. At the same time, singleness of the agricultural chemical also results in technology lag. Attaching importance to change of the present formulation, developing new formulation in accordance with productive and environmental demand, not only can adapt to the needs of sustainable development, but also can make up the deficiency of original chemical development.

Among the agricultural chemical formulations, the liquid formulation is conveniently and widely used. The emulsifiable solution is the most frequently used formulation for a very long time. When processing emulsifiable solution, it needs large amount of organic solvents, such as benzene, toluene, dimethylbenzene. The use of large amount of organic solvents result in not only chemical material waste, but also the inflammability of the solvent, thus they are restricted in transportation, storage and the selection of container. At the same time, they have done harm to enviroment and human health, and have endangered the economic development and the human habitat. Due to the sustainable development strategy, developed countries are limiting or prohibiting the registration of agricultural chemical which are confected using large amount of benzene, toluene, dimethylbenzene. Therefore, development of novel liquid formulation for reducing or eliminating the poisonous organic solvent has already become the agricultural chemical development trend. Among these, water-solubility is one of the major objectives of the agricultural chemical development. Furthermore, the novel formulation has the following functions, adding new property to agricultural chemical, fully achieving the effect of original chemicals, overcoming the deficiency of the existing formulation of agricultural chemical, lowering toxicity and irritability to human and livestock, relieving the harm to crops, improving the physical, chemical and biological property, expanding the application scope, and prolonging the service time of the chemical formulation, etc.

Microemulsion (International formulation code, ME), is the novel formulation adapted to the agricultural chemical development trend. is formulation made up of water, water-fast substance and water soluble substance, original chemicals which is the 0.01-0.1 μparticle dispersing in the water. It is a thermodynamicly homogeneous phase, soluble system. Its appearance takes on transparency. Microcosmic appearance is intumescent big supermolecule dispersoid. It is in fully disperse limit state of aqueous emulsion which is stable in physical and chemical property, and permeate easily through plant, insect tissue and cell. Its absorptivity is high, and prevention effect for the insect is good. At the same time, it can be safely produced, transported and used, resulting in little pollution to enviroment, thus it is beneficial for the improvement of the ecological enviroment.

At present, it has not been reported in China and abroad about the application of natural high molecular material for example fulvic acid in agricultural chemical microemulsion to promote the effect and antagnistic action to toxicity of agricultural chemical. The inventor finds that through long-term intensive research, taking advantage of the low molecular weight of natural high molecular material for example fulvic acid, property of easily to be absorbed by plant, plural functional group, high physiological activity, strong complexing ability, property of soluble in water directly and coherence property of colloid, combining the fulvic acid and agricultural active ingredient in microemulsion can obviously increase the effect of agricultural active ingredient, achieve the purpose of promoting effect and reducing toxicity.

### SUMMARY OF THE INVENTION

The present invention provides an agricultural chemical microemulsion containing agricultural active ingredients and at least one or more natural high molecular material as synergist and/or toxicity antagon selected from the following: fulvic acid, humic acid, chitosan and dextran.

The present invention further provides an agricultural chemical microemulsion preparation method.

Specifically, the present invention provides an agricultural chemical microemulsion, comprising agricultural active ingredients and one or more natural high molecular material as efficient synergist and/or toxicity antagon selected from the following: fulvic acid, humic acid, chitosan and dextran. Preferably, the weight ratio of agricultural active ingredient and fulvic acid is 1:0.001-100 in agricultural chemical microemulsion□more preferably 1:0.01-50, most preferably 1:0.1-30.

In a specific embodiment, the present invention provides an agricultural chemical microemulsion, containing agricultural active ingredient, natural high molecular material (fulvic acid, humic acid, chitosan and/or dextran), cosolvent, emulsifier and water. Weight percentage of ingredients is as follows:

| | |
|---|---|
| agricultural active ingredient | 0.1-30% |
| natural high molecular material | 0.1-10% |
| cosolvent, | 1-10% |
| emulsifier | 5-20% |
| water | the rest |

In the present invention, agricultural active ingredients refer to insecticide (for example organochlorine, organic phosphorus, synthetic pyrethroid, carbamate, nereis toxicity and other insecticide) bactericide (for example organic sulfur, organic arsenic, organic phosphorus, substituted benzene and derivative, azole and the like, antibiotic and other insecticide) hebicide (for example phenoxy carboxylic acid, amide and the like, substituted carbamide and the like, aniline and the like, carbamate and the like, tripyridine and other herbicide) and plant growth hormone etc. Agricultural active ingredient can comprise any one or more than two composition selected from above-mentioned. Preferably, agricultural active ingredients refer to insecticide (for example organic phosphorus, synthetic pyrethroid, carbamate) and other bactericide (for example organic phosphorus, substituted benzene and azole). Preferably, organochlorine insecticide (for example thiodan, benzethazet etc), synthetic pyrethroid insecticide (for example cypermethrin, beta_cypermethrin, Lambda-cyhalothrin, Deltamethrin, beta-cyfluthrin, Bifenthrin, Fenvalerate, esfenvalerate, Permethrin, Fenpropathrin etc,) carbamate insecticide (for example Methomyl., carbosulfano, benfuracarb, BPMC, Propoxur, Mipcin, pirimicarb etc.), organic insecticide (for example triazophos, fenitrothion, pyrimithate, methylpyrimithate, chlorpyrifos, methylchlorpyrifos, Profenofos, phenthoate etc.), nereis toxicity insecticide (for example cartap), other insecticide (for example Abamectin, AbamecetinchlorpfezinEmanectin and its salt, Hexaflumuron, flufenoxuron, Lufenuron, Triflumuron, fenpyroximate, imidacloprid), organic phosphorus bactericide (for example tolelofos-methyl, kitazin, ibp, fosetyl-AL etc.), 1,2,4-triazole bactericide2, (for example triazolone, triadimenol, Diniconazole, myclobutanil, Hexaconazole, flusilazole, Tebuconazole etc.), organic phosphorus herbicide (for example glyphosate, glyphosame, glufosinate-ammonium). Most preferably, agricultural active ingredients are selected from thiodan, Lambda-cyhalothrin, Deltamethrin, cypermethrin and its isomers, triazophosl, carbosulfano□ Methomyl, Abamectin, AbamecetinchlorpfezinEmanectin and its salt for example benzoate, Hexaflumuron, fenpyroximate, imidacloprid, tolelofos-methyl.

High molecular weight agricultural chemical can reduce pollution and toxicity, and be safely employed. Natural high molecular material is the preferable material for the agricultural chemical of macromolecule trend. The natural high molecular material can be for example fulvic acid, humic acid, chitosan and/or dextran.

Taking fulvic acid for an example, it serves as a control release synergist of macromolecule agricultural chemical whose subacidity and water solubility render it extensive combination with microemulsion. It reduces the dosage of agricultural chemical directly, and the application frequency. In addition, fulvic acid takes on an antagonistic action against agricultural chemical, which not only reduces the toxicity of agricultural chemical, but also reduces the remnant of agricultural chemical, therefore increasing the safety of the agricultural chemical.

Fulvic acid is macromolecule organic weak acid with active physiological activity, and is a natural organic substance of humic acid family. Humic acid family contains humic acid, ulmic acid and fulvic acid. The three kinds of humic acids contribute differently to the farming and breed aquatics, fulvic acid is the best. Molecular configuration of fulvic acid is quite complicated. At present its molecular structural formula is yet to be determined, but the molecular unit can be expressed as a pattern: at center is an aromatic nucleus, which is joined by bridge bond (oxygen bridge, methano, imdo group etc.) outside the nucleus are functional groups. These functional groups render a series of physical and chemical properties. Among these, the main active functional groups are hydroxyl group, phenolic group and quinonyl. Molecular weight of fulvic acid is relatively low, and functional group is plural, so it has strong physiological activity.

Fulvic acid, is ordinarily named wujin powder. Its English common name is fulvic acid (below called FA). Element composition: C≧54.82% H≧2.29% O≧41.14% N≧0.66% S≧1.09%, functional group content: total acid radical 8.76 mg equivalent weight/g, thereinto carboxyl 6.12 mg equivalent weight/g, thereinto phenolic hydroxyl group 2.64 mg equivalent weight/g. Fulvic acid is macromolecule non-homogeneous aromatic alcohol acid, faintly acid containing carboxyl, phenolic hydroxyl group etc. It is black-brown powder, taste acid, odorless, water-soluble, alcohol-soluble, dilute acid-soluble, dilute base-soluble and aqueous acetone-soluble. Solution is acid, innocuous, stable in environment.

Fulvic acid is macromolecular non-homogeneous aromatic alcohol acid, and is available from market. For example it can be purchased from Henan Changsheng Industry Co., Ltd., Xinjiang Shuanglong Fulvic Acid Factory and Shanxi Coal Chemistry Institute Chinese Academy of Science. In the present invention, all kinds of fulvic acid can be used. For the convenience of processing, preferably choosing high fulvic acid content product, for example higher than 30%, preferably higher than 75%.

Humic acid possesses similarity with fulvic acid in properties and functions. In the present invention, humic acid refers to humic acid and the like, for example humic acid and humate (potassium, sodium, magnesium, boron, ammonium etc.), nitryl humic acid and nitryl humate (potassium, sodium, magnesium etc.), fulvic acid and its salt (potassium, sodium etc) or two or more selected arbitrarily from the above-mentioned.

In present invention, it is also feasible adopting other natural macromolecule material, for example chitosan or dextran etc. with molecular weight 3000-50000.

Humic acid and the like, chitosan or dextran are all available from market.

In the present invention, cosolvent refers to alcohols (for example ethanol, isopropanol, normal butyl alcohol, normal amyl alcohol, hexanol etc.), ketone(for example acetone, cyclohexanol etc.), amide and the like(for example dimethylformamide etc.), cycloparaffin (for example cyclohexane etc.), arene (for example bezene, toluene, dimethylbenzene, alkyl naphthalene etc.). The cosolvent may also be other kinds in the prior art. Cosolvent may be any one or composition containing more selected from the above-mentioned. Preferably, cosolvent is selected from ethanol, isopropanol, normal butyl alcohol, normal amyl alcohol, acetone, ketohexamethylene, dimethylformamide, cyclohexane, bezene, toluene and dimethylbenzene.

In the present invention, emulsifier refers to non-ion surfactant and/or anion surfactant. Non-ion surfactant may be for example castor oil oxirane addition product, phenethyl hydroxybenzene polyethenoxy ether, phenethyl hydroxybenzene polyethenoxy polypropyoxy ether, phenethyl hydroxybenzene polyethenoxy ether phosphate ester, alkyl hydroxybenzene polyethenoxy ether formaldehyde condensate, benzyl diphenol polyethenoxy ether, alkyl hydroxybenzene polyethenoxy ether, diphenol polyethenoxy ether. Anion surfactant may be for example alkyl benzene sulfonate(calcium, magnesium, sodium C10-C14 alkyl benzene sulfonate), sodium C8-C20-alkyl sulfate (for example sodium dodecyl sulfate) styryl polyethenoxy ether ammiaonia sulfate etc. It is preferable to adopt composition of Anion surfactant and non-ion surfactant. In the embodiment of present invention, it is preferable adopting all kinds of emulsifier available on the market, for example, emulsifier can be selected from agriemulsifier 500, agriemulsifier 600 series (for example agriemulsifier 601-606), agriemulsifier 700 series (for example ningmulsifier 36, ningmulsifier 37, agrimulsifier 700-1, 700-2, agrimulsifier SPF), NP-10, agriemulsifier 1600 series (for example agrimulsifier 1601, 1602, ningmulsifier 33, 34, agrimulsifier 2000, agrimulsifier 11, agrimulsifier 12, PF-690, BY series (for example ningmulsifier 110, 120, 130, 140, EL emulsifier), Tween series (for example Tween-40, Tween-60, Tween-80), Sorpol series(Sorpol KS, Sorpol KD, Sorpol-2676, Sorpol-2678S etc.) or may be any one or composition containing more selected from emulsifier with similar property.

Agricultural chemical microemulsion in the present invention may further comprises stabilizer, which increases the physical and chemical stability. Stabilizers suitable for present invention are 2-epichlorohydrin, butyl diglycidyl ether, polyvinyl glycol diglycidyl ether or sorbierite, isopropanol, normal butyl alcohol, glycol, polyglycol, urea, propylene glycol, glycerine and other stablizer known in the prior art. glycol, polyglycol, urea, glycerin are preferable. These stablizers have double function of stablizer and anti-freeze agent. The dosage is 5-10%.

Water in the present invention can be tap water, deionized water etc., preferably deionized water such as distilled water.

Therefore, the present invention further provides An agricultural chemical microemulsion, weight percentages of ingredients are as follows:

| | |
|---|---|
| agricultural active compound | 0.1-30% |
| natural high molecular material | 0.1-10% |
| cosolvent, | 1-10% |
| emulsifier | 5-20% |
| stablizer | 5-10% |
| water | the rest |

The natural high molecular material is selected from fulvic acid, humic acid, chitosan and/or dextran.

In addition, agricultural chemical microemulsion in the present invention may further be added other processing assistant ingredient for example antifreeze (glycol, propylene glycol, glycerin, polyglycol, sorbierite etc.), preservative (for example formaldehyde) etc. The dosage of processing assistant agent accounts for 0.1-10%.

It is well known in the art that agricultural chemical active ingredient content varies in a certain range according to different agricultural chemical activity. For example, as abamecetinChlorpfezinEmanectin benzoate is concerned, its content can be reduced to 0.1% in microemulsion in the present invention. For general application, agricultural chemical active ingredient content varies in 1-20% as ordinary agricultural chemical is concerned.

Accordingly, in present invention, agricultural chemical active ingredient content in microemulsion varies in a certain range, fulvic acid content in present invention may be various. As mentioned, in present invention, fulvic acid varies in a certain weight ratio according to different agricultural chemical active ingredient content in microemulsion so as to achieve the purpose of the present invention.

The present invention further provides a microemulsion preparation method in which natural macromolecule material (ie fulvic acid, humic acid) is in combination with agricultural chemical active ingredient. Microemulsion in the present invention can be prepared using conventional method and apparatus. reference to Agricultural chemical Formulation Process the second edition page 406-408 editor in chief Liu Bulin, Chemical Industry Press.

Preferably, the present invention provides an agricultural chemical microemulsion preparation method including the following steps: dissolving agricultural active ingredient in cosolvent, adding emulsifier, then adding the other processing assistant ingredient, for example when it is needed, then adding stabilizer, stirring fully to uniformity, then pouring them into fulvic acid water solution in homogenizer, stirring violently to uniformity.

More preferably, microemulsion in the present invention is prepared through emulsification technology and nanotechnology for example flow depth ultramicro dispersion and assembly. That is, in preparation of microemulsion in present invention, the method of flow depth ultramicro dispersion and assembly is employed following the mixing of all constituents in the forgonging step. It is obvious to a person of ordinary skill in the field that homogenizing degree can be decreased due to the ensuing nanometertechnology process.

The flow depth ultramicro dispersion and assembly method comprises accelerating superhighpressure flow by ejector, forming high velocity jet, then driving the solid granula thereinto to a high velocity motion. Though high velocity colliding, cutting, vacating and striking with diamond or other super hard material, violent collide and ultrasonicvibration produced by diamond make solid material to be superfine, homogenize, superemulsify and disperse. The flow depth ultramicro dispersion and assembly method mainly processes the solid granula suspended in liquid, or produces the emulsion with good suspension, dispersion and emusification effect. This method for the present is starting to be employed in medicine, food and healthcare product, material, electronics etc, but it is the first time that it is used in processing agricultural chemical formulation.

When using flow depth ultramicro dispersion and assembly method, the liquid mixing with goods to be processed is pressurized by high pressure pump, then adding into specially-designed vibrationway, forming the mode of motion comprising high velocity colliding, cutting, vacating and striking with other jet. Then the strong bow wave comes up, which makes the suspended granula smashing instantly, superfining or exceedingly dispersed, emulsifiing and synthesizing.

Flow depth ultramicro dispersion and assembly method can be implemented through apparatus available on the market, for example PEL-20 type NANO MAKER (product of NANOMIZER INC), and also through similar modified apparatus.

It is preferable to adopt flow depth ultramicro dispersion and assembly method (ie, nanotechnology process). In the method, emulsification and nanotechnology make active ingredient granula superfining and fully dispersed, accordingly promoting the adhesion and penetrating power of agricultural chemical to crop and target insect, and especially the synergistic effect to resistant body. The method reduces the agricultural chemical pollution farthest, increases the physical and chemical stability of agricultural chemical, prolongs the service time of the chemical formulation.

In present invention, it is preferable to adopt FAn as natural macromolecule material. Experiment shows that, FA possesses toxicity antagonistic function, antibacterial and antidisease function etc.

Action mechanism of FA: Active group of FA is binded with that of agricultural chemical through chemical reaction or physical chemistry method. Binding can be achieved through forming covalent bond, weak hydrogen bond, static gravitation, drainage action, van der waals force or space conjunction. Agricultural chemical complex after binding with FA promotes the effect of product.

FA has antibacterial and antidisease function. Antidisease ability of plant is in positive correlation with dioxygenase activity, which is acknowledged by botanist in China and abroad. FA can promote the dioxygenase activity effectively. The extent can be 20-60%, even multiplying to some crops. FA inhibits remarkably the blackspot disease of sweet patato, root rot, downy mildew of cucumber, leaf spot of peanut, rot apple trunk etc. Salt of FA is lanched into market as non-pollution product, and win the applause of consumer.

FA has the following virtue as synergist: First, innocuity and no odor. High purity FA(95%) has already been used in medicine and feed for huaman and livestock. Second, lowing cost, the cost can be lowered about 30%-70% than majority of agricultural synergist. Third, substantial reduction of the toxicity of agricultural chemical. Fourth, disease-resistant function. It is a new effective plant growth regulator. Agricultural chemical FA complex—FA combined with other agricultural active ingredient has double function of agricultural chemical and hormone. except for insect prevention it can promote dramatically the drought-resistant, cold-resistant property and growth. Fulvic acid is a multifunctional synergist of agricultural chemical, and especially takes a positive role in non-polluted integrated pest control and environmental protection.

Research and experiment of present invention show that macromolecule material in microemulsion can promote effect and reduce the toxicity.

Taking fulvic acid for example, combining FA with agricultural chemical such as insecticide, bactericide, herbicide can obviously increase the effect of agricultural chemical and reduce the toxicity. More concretely, it is solubilization. FA can be acted as surfactant. Its metal salt is lower than water in surface tension which can produces substaintial dispersion and emulsification effect, promotes soluble capacity of soluble agricultural chemical. Synergistic action: FA can increase the absorption of plant to agricultural chemical, promote the biological activity of agricultural chemical and plant growth regulator, and improve the effect of agricultural chemical. Control release action: FA inhibits the decomposition rate of agricultural chemical, moreover the greater the FA's volume, the slower the decomposition rate. Reducing toxicity action: FA can inactivate enzyme sensitive to agricultural chemical, inspire the activity of enzyme which is antagnistic to agricultural chemical, alleviate and reduce the toxicity of agricultural chemical.

The advantages of present invention are, its medium is water, and it is a two-phase (especially O/W type) thermodynamically stable system. The active ingredient size range from 10 to 70 nm. It features that synergistic effect is good. The agricultural chemical is enviroment friendly, highly active, safe, and the cost is low. In addtition, it has vast market capacity.

Agricutural chemical microemulsion in the present invention can reduce the use of organic solvent, and the synergistic effect is remarkable, which reduces the agricultural chemical pollution to environment, promote the safety. At the same time, processing property of agricultural chemical formulation in the present invention increases the storage stability of agricultural chemical, adhesiveness and osmosis to plant, the effect of prevention for insect, period of validity.

Example listed below are not meant to limit the present invention.

### DESCRIPTION OF THE SPECIFIC EMBODIMENTS

Agricultural chemical microemulsions in the present invention are prepared according to the following method:

Through dissolving original agricultural chemical in cosolvent, adding emulsifier, fulvic acid, adding stabilizer when needed, stirring fully to uniformity, then pouring them into dispersion medium-water solution in homogenizer, stirring violently to uniformity, agricultural chemical microemulsion is obtained. In a certain embodiment, fulvic acid can be dissolved in water beforehand. If needed, flow depth ultromicro dispersion and assembly method is employed to process the product again. Microemulsion processed by the latter method is marked by * in the following examples.

### Formulation Example 1

### 2.5% FA Lambda-cyhalothrin Microemulsion *

25 kg Lambda-cyhalothrin was dissolved in 20 kg toluene, then 10 kg agricultural chemical emulsion 500^{#}, 20 kg 700^{#}, fulvic acid 5 kg were added. The resulting mixture was stirred fully to uniformity. Then the resulting solution was poured into dispersion medium —920 kg water. It was stirred violently to uniformity and clarity in homogenizer. Then 1000 kg 2.5% FA Lambda-cyhalothrin microemulsion * was prepared.

The formulation was processed using flow depth ultramicro dispersion and assembly method in the NANO MAKER at a pressure of 300˜2500 kg produced by high pressure pump. Then 1000 kg 2.5% FA Lambda-cyhalothrin microemulsion * was prepared.

Technical indexes of the two prepared microemulsions are as follows:

| Index name | Index |
|---|---|
| Lambda-cyhalothrin (% m/m) (20° C.) | ≧2.5 |
| PH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 2

### 20% Tolelofos-Methyl Microemulsion

Fulvic acid 20 kg was dissolved in water beforehand. Tolelofos-methyl 200 kg was dissolved in toluene 200 kg and dimethyl formamide 5 kg. Then 70 kg 500^{#} and 100 kg 700^{#} were added. The resulting mixture was stirred fully to uniformity, then poured into dispersion medium—water containing fulvic acid (20 kg fulvic acid, 405 kg water) while it was stirred violently to uniformity in homogenizer. Then 1000 kg 20% FA tolelofos-methyl microemulsion was prepared. Technical indexes of the prepared microemulsions are as follows:

| Index name | Index |
|---|---|
| tolelofos-methyl content (% m/m)(20° C.) | ≧20 |
| PH value | 4.0-6.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 3

### 5% FA Hexafumuron Microemulsion

Fulvic acid 20 kg was dissolved in water beforehand. Hexafumuron 50 kg was dissolved in toluene 200 kg and dimethyl formamide 5 kg. Then 30 kg 500^{#}, 90 kg 700^{#} and 20 kg BY-130 microemulsion were added. Then the resulting mixture was stirred fully to uniformity, then poured into dispersion medium —656 kg water contain fulvic acid while the resulting solution was stirred violently to uniformity in homogenizer. So the 5% hexafumuron microemulsion was prepared. Technical indexes of the prepared microemulsions are as follows:

| Index name | Index |
|---|---|
| hexafumuron content (% m/m)(20° C.) | ≧5 |
| PH value | 4.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 4

### 15% Triazophos Microemulsion

Fulvic acid 20 kg was dissolved in water beforehand. Triazophos 150 kg was dissolved in toluene 150 kg and acetone 5 kg. Then 90 kg 500^{#}, 110 kg 690^{#}, 20 kg EL-40 microemulsiondding were added while the resulting mixture was stirred fully to uniformity, then poured into dispersion medium —425 kg water containing fulvic acid, while it was stirred violently to uniformity in homogenizer. Then 1000 kg 15% FA triazophos microemulsion was prepared. Technical indexes of the prepared microemulsions are as follows:

| Index name | Index |
|---|---|
| triazophos content (% m/m)(20° C.) | ≧15 |
| pH value | 3.0-6.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 5

### 20% FA Carbosulfano Microemulsion

Fulvic acid 20 kg was dissolved in water beforehand. 200 kg carbosulfano was dissolved in 200 kg toluene, then 50 kg 500^{#}, 90 kg 1601^{#} and 70 kg12^{#} microemulsion were added while the resulting mixture was stirred fully to uniformity. Then the resulting solution was poured into dispersion medium —390 kg water containing fulvic acid. The solution was stirred violently to uniformity in homogenizer. So 1000 kg 20% FA carbosulfano microemulsion was prepared. Technical indexes of the prepared microemulsions are as follows:

| Index name | Index |
|---|---|
| carbosulfano microemulsion (% m/m) | ≧20 |
| (20° C.) | |
| pH value | 4.0-6.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 6

### 20% FA Thiodan Microemulsion

Fulvic acid 20 kg was dissolved in water beforehand. 200 kg thiodan was dissolved in 200 kg dimethylbenzene, then 60 kg 500^{#}, 110 kg 700^{#} and 50 kg12^{#} microemulsion were added while the resulting mixture was stirred fully to uniformity. The resulting solution was then poured into dispersion medium —380 kg water containing fulvic acid, while stirred violently to uniformity in homogenizer. 1000 kg 20% FAthiodan microemulsion was prepared. Technical indexes of the prepared microemulsions are as follows:

| Index name | Index |
|---|---|
| thiodan content (% m/m)(20° C.) | ≧20 |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 7

### 5% FA Fenpyroximate Microemulsion

Fulvic acid 20 kg was dissolved in water beforehand. 50 kg fenpyroximate was dissolved in 200 kg toluene, then 40 kg 500^{#}, 60 kg 700^{#} and 40 kg 11^{#} microemulsion were added while the resulting mixture was stirred fully to uniformity, then the solution was poured into dispersion medium —610 kg water containing fulvic acid, while it was stirred violently to uniformity in homogenizer. 1000 kg 5% FA fenpyroximate microemulsion was prepared. Technical indexes of the prepared microemulsions are as follows:

| Index name | Index |
|---|---|
| fenpyroximate content (% m/m)(20° C.) | ≧5 |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 8

### 0.2% FAn abamecetinChlorpfezinEmanectin benzoate Microemulsion

Fulvic acid 30 kg was dissolved in water beforehand. 2 kg abamecetinChlorpfezinEmanectin benzoate was dissolved in 40 kg toluene, then 40 kg 500^{#} and 70 kg 690^{#} were added while the resulting mixture was stirred fully to uniformity, then it was poured into dispersion medium-848 kg water containing fulvic acid. The resulting solution was stirred violently to uniformity in homogenizer. 1000 kg 0,5% FAn abamecetinChlorpfezinEmanectin benzoate microemulsion was prepared. Technical indexes of the prepared microemulsions are as follows:

| Index name | Index |
|---|---|
| AbamecetinChlorpfezinEmanectin benzoate | ≧0.5 |
| content (% m/m)(20° C.) | |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 9

### 20% FA Triazolone Microemulsion

Fulvic acid 20 kg was dissolved in water beforehand. Triazolone 200 kg was dissolved in cyclohexanone 200 kg and isopropanol 50 kg, then 40 kg 500^{#}, 80 kg OP-10 and 30 kg agriemulsion 2201 were added while the solution was stirred to make triazolone fully dissolving, then the solution was poured into dispersion medium-400 kg water containing fulvic acid. The resulting solutin was stirred violently to uniformity in homogenizer. 1000 kg 20% FA triazolone microemulsion was prepared. Technical indexes of the prepared microemulsions are as follows:

| Index name | Index |
|---|---|
| triazolone content (% m/m)(20° C.) | ≧20 |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 10

### 2.5% FA Deltamethrin Microemulsion *

Fulvic acid 20 kg was dissolved in water beforehand. 25 kg Deltamethrin was dissolved in 100 kg toluene, then 30 kg 500^{#}, 60 kg 700^{#} and 20 kg 690^{#} were added while the resulting mixture was stirred fully to uniformity, then poured into dispersion medium —765 kg water containing fulvic acid (20 kg fulvic acid, 745 kg water). The solution was stirred violently to uniformity in homogenizer. At last flow depth ultromicro dispersion and assembly method was employed to process the product again (similar to formulation example 1). 1000 kg 2.5% FA Deltamethrin microemulsion* was prepared.

If the method of flow depth ultromicro dispersion and assembly was not employed after the mixing of all constituents to uniformity, the 2.5% FA Deltamethrin microemulsion was prepared.

Technical indexes of the prepared microemulsions are as follows:

| Index name | Index |
|---|---|
| Deltamethrin content (% m/m)(20° C.) | ≧2.5 |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Formulation Example 11

### 5% FA Imidacloprid Microemulsion *

Fulvic acid 20 kg was dissolved in water beforehand. Imidacloprid 50 kg was dissolved in toluene 100 kg and dimethyl formamide 20 kg, then 30 kg 500^{#}, 60 kg BY-130 and 20 kg 690^{#} were added. Then the resulting mixture was stirred fully to uniformity, then poured into dispersion medium —720 kg water containing fulvic acid (20 kg fulvic acid 700 kg water). The solution was stirred violently to uniformity in homogenizer. At last flow depth ultromicro dispersion and assembly method was employed to process the product again (similar to formulation example 1). 1000 kg 5% FA imidacloprid microemulsion* was prepared.

If the method of flow depth ultramicro dispersion and assembly was not employed after the mixing of all constituents to uniformity, the 5% FA imidacloprid microemulsion was prepared.

Technical indexes of the prepared microemulsions are as follows:

| Index name | Index |
|---|---|
| imidacloprid content (% m/m)(20° C.) | ≧5 |
| pH value | 5.0-7.0 |
| emulsion stability (200 times dilution) | eligibility |
| low temperature stability (0 ± 2° C.) | eligibility |
| Hot storage stability (54 ± 2° C.) | eligibility |
| Temperature range of clarity (0-50° C.) | eligibility |

Note:
low temperature stability and hot storage stability are detected at least once every three months

### Toxicity Example 1

### Animal Toxicity Experiment of Lambda-Cyhalothrin Microemulsion*

1). Acute Oral Toxicity Experiment

Wistar rat was chosen for the experiment. Male and female were respectively fed with 1000, 464, 215 and 100 mg/kg Lambda-cyhalothrin microemulsion* according to the Horn's method. Toxicosis symptom and death time of the animal were observed and recorded continuously for 14 days.

Male and female oral LD₅₀ calculated through death result are respectively as follows:
male rat: 387 mg/kg(320-451 mg/kg)
female rat: 405 mg/kg

2). Acute Skin Toxicity Experiment

Wistar rat was chosen for experiment. Male and female were respectively fed with 1000, 464, 215 and 100 mg/kg Lambda-cyhalothrin microemulsion *according to the Horn's method. Toxicosis symptom and death time of the animal were observed and recorded continuously for 14 days.

Male and female skin LD₅₀ calculated through death result are respectively as follows:
male rat: >2150 mg/kg
female rat: >2150 mg/kg

3). Acute Skin Irritability Experiment

White rabbit with long ear was chosen for the experiment. The experiment was carried out according to regulation of PRC criteria GB15670 Agricutural chemical register and toxicological experiment method, then it was observed continuously for 14 days after applicating Lambda-cyhalothrin microemulsion *. The result was compared to that without using microemulsion on the other skin of the rabbit.

According to acute toxicity criteria of PRC criteria GB15670 Agricutural chemical register and toxicological experiment method and experimental result, the Lambda-cyhalothrin microemulsion * is “no irritating” to skin.

4) 2.5% FA Lambda-Cyhalothrin Microemulsion *Eye Irritability Experiment

White rabbit with long ear was chosen for the experiment. The experiment is carried out according to regulation of PRC criteria GB15670 Agricutural chemical register and toxicological experiment method, then observed continuously for 14 days after applicating Lambda-cyhalothrin microemulsion *. The result was compared to that without using microemulsion on another eye of the rabbit.

According to eye irritability criteria of PRC criteria GB15670 Agricutural chemical register and toxicological experiment method and experimental result, the Lambda-cyhalothrin microemulsion * is “no irritating” to eye.

In addition, the parallel experiment of 2.5% Lambda-cyhalothrin microemulsion and 2.5% FA Lambda-cyhalothrin microemulsion * prepared in formulation example 1 shows that acute skin toxicity experiment and the acute skin irritability experiment have the same results. Acute oral toxicity experiment and eye irritability experiment results are as follows:
1, 2.5% Lambda-cyhalothrin microemulsion *
male rat: 271 mg/kg(200-369 mg/kg) female rat: 316 mg/kg
eye irritability grade is “slight irritating”.
2, 2.5% FA Lambda-cyhalothrin microemulsion *
male rat: 407 mg/kg(350-469 mg/kg) female rat: 442 mg/kg
eye irritability grade is “no irritating”.

Experimental results show that Adding FA can remarkably reduce the toxicity of agricultural chemical microemulsion, moreover, agricultural chemical microemulsion with FA can reduce the toxicity further after processed using flow depth ultramicro dispersion and assembly method.

### Toxicity Example 2

### Animal Toxicity Experiment of Deltamethrin Microemulsion *

The parallel experiment of 2.5% Deltamethrin microemulsion and 2.5% FA Deltamethrin microemulsion and 2.5% FA Deltamethrin microemulsion * prepared in formulation example 10 shows that:

1). Oral Acute Toxicity Experiment

Wistar rat was chosen for experiment. Male and female were respectively fed with 1000, 464, 215 and 100 mg/kg Deltamethrin microemulsion * according to the Horn's method and observed continuously for 14 days and recorded the toxicosis symptom and death time of the animal.

Male and female oral LD₅₀ calculated through death result are respectively as follows:
male rat:: 475 mg/kg
female rat: 492 mg/kg

2). Acute Skin Toxicity Experiment

Wistar rat was chosen for the experiment. Male and female were respectively fed with 2150, 1000, 464, 215 mg/kg Deltamethrin microemulsion * according to the Horn's method and observed continuously for 14 days and recorded the toxicosis symptom and death time of the animal.

Male and female skin LD₅₀ calculated through death result are respectively as follows:
male rat: >2150 mg/kg female rat: >2150 mg/kg

3). Acute Skin Irritability Experiment

White rabbit with long ear was chosen for the experiment. The experiment was carried out according to regulation of PRC criteria GB15670 Agricutural chemical register and toxicological experiment method, then observed continuously for 14 days after applicating Deltamethrin microemulsion * . The result was compared to that without using microemulsion on the other skin of the rabbit.

According to acute toxicity criteria of PRC criteria GB15670 Agricutural chemical register and toxicological experiment method and experimental result, the Deltamethrin microemulsion * is “no irritating” to skin.

4). Eye Irritability Experiment

White rabbit with long ear was chosen for the experiment. The experiment was carried out according to regulation of PRC criteria GB15670 Agricutural chemical register and toxicological experiment method, then observed continuously for 14 days after applicating Deltamethrin microemulsion *. The result was compared to that without using microemulsion on another eye of the rabbit.

According to eye irritability criteria of PRC criteria GB15670 Agricutural chemical register and toxicological experiment method and experimental result, the Deltamethrin microemulsion * is “no irritating” to eye.

In addition, the parallel experiment of 2.5% Deltamethrin microemulsion * and 2.5% FA Deltamethrin microemulsion * prepared in formulation example 1 shows that acute skin toxicity experiment and the acute skin irritability experiment have the same result. Acute oral toxicity experiment and eye irritability experiment results are as follows:
1, 2.5% Deltamethrin microemulsion *
male rat:: 314 mg/kg female rat: 338 mg/kg
eye irritability grade is “slight irritating”
2, 2.5% FA Deltamethrin microemulsion *
male rat:: 514 mg/kg female rat: 531 mg/kg
eye irritability grade is “no irritating”.

Experimental results show that adding FA can remarkably reduce the toxicity of agricultural chemical microemulsion, moreover, agricultural chemical microemulsion with FA can reduce the toxicity further after processed using flow depth ultramicro dispersion and assembly method.

### Toxicity Example 3

### Animal Toxicity Experiment of 5% Imidacloprid Microemulsion

The parallel experiment of 5% imidacloprid microemulsion, 5% FA imidacloprid microemulsion and 5% imidacloprid microemulsion *prepared in formulation example 11 shows that:

1). Oral Acute Toxicity Experiment

Wistar rat was chosen for the experiment. Male and female were respectively fed with 2150, 1000, 464, 215 mg/kg 5% imidacloprid microemulsion according to the Horn's method, then observed continuously for 14 days and recorded the toxicosis symptom and death time of the animal.

Male and female oral LD₅₀ calculated through death result are respectively as follows:
male rat:: 871 mg/kg
female rat: 892 mg/kg

2). Acute Skin Toxicity Experiment

Wistar rat was chosen for the experiment. Male and female were respectively fed with 4640, 2150, 1000, 464 mg/kg 5% imidacloprid microemulsion according to the Horn's method, then observed continuously for 14 days and recorded the toxicosis symptom and death time of the animal.

Male and female skin LD₅₀ calculated through death result are respectively as follows:
male rat: >4,640 mg/kg
female rat: >4,640 mg/kg

3} Acute Skin Irritability Experiment

White rabbit with long ear was chosen for the experiment. The experiment was carried out according to regulation of PRC criteria GB15670 Agricutural chemical register and toxicological experiment method, then observed continuously for 14 days after applicating agricultural chemical. The result was compared to that without using microemulsion on the other skin of the rabbit.

According to acute toxicity criteria of PRC criteria GB15670 Agricutural chemical register and toxicological experiment method and experimental result, the 5% imidacloprid microemulsion is “no irritating” to skin.

4). Eye Irritability Experiment

White rabbit with long ear was chosen for the experiment. The experiment was carried out according to regulation of PRC criteria GB15670 Agricutural chemical register and toxicological experiment method, then observed continuously for 14 days after applicating Lambda-cyhalothrin microemulsion *. The result was compared to that without using microemulsion on another eye of the rabbit.

According to eye irritability criteria of PRC criteria GB15670 Agricutural chemical register and toxicological experiment method and experimental result, the 5% imidacloprid microemulsion is “nonirritant” to eye.

In addition, The parallel experiment of 5% imidacloprid microemulsion prepared in formulation 1 and 5% imidacloprid microemulsion * prepared in formulation example 11 shows that acute skin toxicity experiment, the acute skin irritability and eye irritability experiment have the same result. Acute toxicity experiment shows that:
1, 5% imidacloprid microemulsion
male rat:: 795 mg/kg, female rat: 813 mg/kg.
2, 5% FA imidacloprid microemulsion*
male rat:: 906 mg/kg, female rat: 927 mg/kg.

Experimental results show that adding FA can remarkably reduce the toxicity of agricultural chemical microemulsion, moreover, agricultural chemical microemulsion with FA can reduce the toxicity further after processed using flow depth ultramicro dispersion and assembly method.

### Experiment Example 1

### Indoor Virulence Measurement Experiment of 2.5% FA Lambda-Cyhalothrin Microemulsion for helicoverpAn armigera Hübner

This example is indoor virulence measurement experiment for helicoverpAn armigera Hübner.

Praparations for Experiment:
1. 2.5% Lambda-cyhalothrin microemulsion * missible oil (available on the market, produced by syngeta corp.).
2. 2.5% FA Lambda-cyhalothrin microemulsion (preparation of present invention in example 1)
3. 2.5% FA Lambda-cyhalothrin microemulsion * (preparation of present invention in example 1)

Note: The composotion of praparation 2 and 3 are same, and the difference is that the former did not be reprocessed using flow depth ultramicro dispersion.

3 years old, helicoverpAn armigera Hübner sensitive strain was chosen for the experiment (compared to sensitive population, resistability is 5-10 times) The experiment was done in Institue of Plant Protection, Chinese Academy of Agricultural Sciences,

Larva immersion method was used in this experiment. Contact toxicity of above praparations were determined using larva immersion method. Praparations concentration were respectively 50, 25, 12,5, 6,25, 3,125, 1.56 ppm. Each treatment of specific praparation concentration was repeated 6 times, and 48 larvas were investigated in each repeated experiment. Larvas were immersed for 5 seconds, then taken out, and put on the absorbent paper. Unwanted liquor was absorbed, larvas were put into 24 hole test-box respectively and death rate was researched after cultured for 24, 48 hours in constant temperature incubator (to see the following table).

Results of indoor virulence measurement of Lambda-cyhalothrin formulation for helicoverpAn armigera Hübner.

| | | | LD₅₀ (95% | | |
|---|---|---|---|---|---|
| Praparations for | check | virulence regression | confidence limit) | LC₉₀ | synergia |
| experiment: | time | equation (Y =) | (μg/ml) | (μg/ml) | times |
| Praparation 3 | 24 h | 4.4101 + 1.9124x | 2.66(1.72-4.24) | 11..35 | 2.93 |
| Praparation 2 | | 4.1040 + 2.0153x | 2.78(1.87-4.36) | 12.06 | 2.79 |
| Praparation 1 | | 2.9708 + 2.2803x | 7.76(5.99-10.06) | 28.35 | 1.0 |
| Praparation 3 | 48 h | 4.5712 + 1.8549x | 2.41(1.52-4.06) | 20.25 | 3.08 |
| Praparation 2 | | 4.1273 + 2.0689x | 2.64(1.68-4.15) | 22.02 | 2.82 |
| Praparation 1 | | 3.9439 + 2.3593x | 7.44(5.77-9.59) | 26.03 | 1.0 |

Note:
synergia times = value of LC₅₀ of comparison praparation/value of LC₅₀ of synergia praparation

### Experiment Example 2

### Field Effect of Medicine Experiment of 2.5% FA Lambda-Cyhalothrin Microemulsion for helicoverpAn armigera Hübner

This example is field effect experiment for helicoverpAn armigera Hübner.

Condition of Experiment: Hebei experimental cotton field was chosen for the experiment. Ordinary cotton variety 492 was chosen for experiment, and seeded on the end of Apral. In test plot, management practices and growth vigor were consistent and appearance of worm burden was medium. Most larvas were 3-4 years old. The praparations were used 2 times in the whole test period.

Praparations for Experiment:
1, 2.5% gongfu® missible oil (Lambda-cyhalothrin microemulsion available on the market, produced by syngeta corp.)
2, 2.5% FA Lambda-cyhalothrin microemulsion (preparation of present invention in example 1)
3,2.5% FA Lambda-cyhalothrin microemulsion * (preparation of present invention in example 1)

Note: The composotion of praparation 2 and 3 were same, and the difference was that the former did not be reprocessed using flow depth ultramicro dispersion.

Spraying Method: Each of the 5 treatments was repeated 2 times. The area of test plot was 15 m² with random grouping arrangement. Spraying was done generally using KIM-9-MATABI knapsack-type hand sprayer.

Investigation Method: Five points sampling method was used in every plot before spraying. The number of all live larvas on 5-10 cotton was positioningly investigated, and considered as cardinal number of larva. Number of larvas was surveyed on the 1st and 7th day after using preparations.

Experiment results show that prevention and control effect of praparation 3 and 2 for helicoverpAn armigera Hübner is superior remarkably to praparation 1. Significance test shows that the prevention and control effect is remarkable. Results are described in detail in the following table.

Result of field effect of medicine of Lambda-cyhalothrin formulation for helicoverpAn armigera Hübner.

| | | | | | | the 7st day after using | | |
|---|---|---|---|---|---|---|---|---|
| | | | the 1st day after using praparations | | | praparations | | |
| | | number of | | | calibrated | | | calibrated |
| praparations for | | live aphis | | rate of | prevention | | | prevention |
| experiment and | | before using | number of | decrease | and control | number of | rate of | and control |
| concentration | Repeatition | praparations | live larva | (%) | effect | live larva | decrease (%) | effect |
| Praparation 3 | 1 | 51 | 0 | 100 | 99a | 0 | 100 | 100a |
| 1000× | 2 | 51 | 1 | 98 | | 0 | 100 | |
| Praparation 2 | 1 | 50 | 1 | 98 | 98a | 0 | 100 | 99a |
| 1000× | 2 | 50 | 1 | 98 | | 1 | 98 | |
| Praparation 1 | 1 | 50 | 3 | 94 | 95a | 3 | 94 | 94.9b |
| 1000× | 2 | 51 | 2 | 96 | | 2 | 96.1 | |
| Praparation 3 | 1 | 50 | 1 | 98 | 99a | 1 | 98 | 99a |
| 1500× | 2 | 50 | 0 | 100 | | 0 | 100 | |
| Praparation 2 | 1 | 50 | 3 | 94 | 96a | 2 | 96 | 97b |
| 1500× | 2 | 51 | 1 | 98 | | 1 | 98 | |
| Praparation 1 | 1 | 50 | 7 | 86.3 | 88.2c | 6 | 88.2 | 88.9c |
| 1500× | 2 | 51 | 5 | 90 | | 5 | 90 | |
| Praparation 3 | 1 | 50 | 1 | 98 | 97a | 2 | 96 | 95b |
| 2000× | 2 | 51 | 2 | 96 | | 3 | 94 | |
| Praparation 2 | 1 | 51 | 3 | 94.1 | 94.1a | 3 | 94.1 | 94.1b |
| 2000× | 2 | 54 | 3 | 94.1 | | 3 | 94.1 | |
| Praparation 1 | 1 | 50 | 10 | 80 | 81a | 9 | 82 | 81.7d |
| 2000× | 2 | 50 | 9 | 82 | | 9 | 82 | |
| CK | 1 | 30 | 30 | 0 | | 30 | 0 | |
| | 2 | 31 | 31 | 0 | | 30 | 3.2 | |

Test time: Jul. 4-11, 2003, English letters following the numbers are different that indicates significant difference (P=0.05,HSD).

Field experiment shows that chemical injury does not appear within the test concentration, and prevention and control effect of microemulsion of present invention for helicoverpAn armigera Hübner has significant difference to congeneric preparations.

### Biological Example 3

### Indoor Virulence Measurement Experiment of 20% FA Tolelofos-Methyl Microemulsion for sclerotinia scle roiorum

This example is indoor virulence measurement experiment for sclerotinia scle roiorum.

Chemical Preparations for the Experiment
1, 20% tolelofos-methyl missible oil (available on the market, produced by Zhejiang Province Huangyan Pesticide Plant)
2, 20% tolelofos-methyl microemulsion
3, 20% FA tolelofos-methyl microemulsion (preparation of this invention in example 2)

Note: The composition and preparing process of preparation 2 and 3 are similar, while the difference is that the former does not contain FA.

Object for Experiment:

Sclerotinia scle roiorum.

Method of the Experiment:

Activities of preparation 1, 2, and 3 for sclerotinia scle roiorum are determined indoor using toxin containing medium method. 45 ml PSA culture medium was put into 100 ml delta-bottle, cooled to 45˜50 deg c. after sterilization, and 5 ml of various test preparations was added according to preconcerted dosage. Then, the samples were poured to three culture dishes of 9 cm diameter after shaking up, and the plates containing preparations with various concentrations were prepared and the sterilized water was control. 5 mm diameter lawn was obtained from the edge of bacterial colony cultured for 7 days and inoculated in petri dish. The face of lawn was placed downwards. 5 concentrations were arranged for each preparation, and each concentration was treated repeatedly 3 times. The lawn was cultured for 4 days at constant temperature of 24 deg c. and colony diameter was determined by cross-scoring method. Value of EC₅₀ was calculated and obtain virulence regression equation was obtained. Bacteriostasis activity of preparations was evaluated. Result of virulence measurement show that at room and in vitro condition, fulvic acid possesses no bacteriostasis effect for sclerotinia scle roiorum and preparation 3 possesses better effect.

Result of Virulence Measurement of Tolelofos-Methyl Microemulsion for sclerotinia scle roiorum

| | virulence | correlation | | |
|---|---|---|---|---|
| preparations for | regression equation | coefficient | LC₅₀ | LC₉₀ |
| experiment: | (Y=) | r | (mg/L) | (mg/L) |
| preparation 1 | Y = 3.7439 + 2.1126X | 0.9646 | 3.647 | 25.92 |
| preparation 2 | Y = 4.0749 + 1.6112X | 0.9934 | 3.281 | 20.46 |
| preparation 3 | Y = 5.4198 + 1.6107X | 0.9967 | 0.3988 | 5.644 |

### Biological Example 4

### Field Effect of 20% FA Tolelofos-Methyl Microemulsion for sclerotinia scle roiorum

This example is field effect of medicine experiment for sclerotinia scle roiorum.

Chemical Preparations for Experiment
1, 20% tolelofos-methyl missible oil (available on the market, produced by Zhejiang Province Huangyan Pesticide Plant)
2, 20% tolelofos-methyl microemulsion
3, 20% FA tolelofos-methyl microemulsion (preparation of this invention in example 2)

Note: the composition and preparing process of preparation 2 and 3 are similar, while the difference was that the former did not contain FA.

Objects for Prevention and Cure:

Rhizoctonia solani K., Colletotrichum gossypii S.

Experiment Method:

The experiment was done in Institue of Plant Protection, Chinese Academy of Agricultural Sciences. The variety for the experiment was CRICAAS 35 planted on Apr. 21, and naked seed was sowed according to 28 kg/hm ⁻². Field seedling illness took place equably (middle and slightly bad) and field administration was consistent. This experiment containing 4 treatments was compared to blank and repeated 4 times. The area of each plot was 25 m² with random grouping arrangement.

Field Experiment Research:

Channels were dig immediately among row intervals after seeding and 100 seeds were inseminated equably. Number of seedling emergence was surveyed every three days and rate of seedling emergence was calculated. Spot-fixing survey started while 50% seedling emergence is achieved. Number of total plant and dead seedling was surveyed every three days and effect of seedling protection was calculated. After the last survey, 100 cotton seedlings were pulled out from each area for investigating disease index and the rate of various seedling illnesses and effect of disease protection was calculated. Germination experiment was done in room. 0.5 cm sterilized treatment fluvial sand (20% water content) was put in culture dish of 180 mm diameter. 100 seeds were inseminated in each dish and cultured at (25±1) deg c. in constant temperature incubator. Germination number was surveyed and germination rate was calculated. Indoor bacteriostasis determining: 0.5 cm diameter blocks of mycelium picked from the front end of cultured mycelium were inoculated to PDA culture medium of various preparations (preparation 1 to 3 were diluted 10000 times) and cultured at (18±1) deg c (inhibiting Rhizoctonia solani K.) or (25±1)deg c. (inhibiting Colletotrichum gossypii S.) in growth incubator. Each treatment was repeated 4 times, colony diameter was determined and bacteriostasis rate was calculated. And the above-mentioned data was proceeded by Duncan's test (SSR) and multiple comparison to evaluate the treating difference of various preparations in this experiment.

Effect evaluation of tolelofos-methyl for bacteria: preparation 3 has prominent effect for inhibiting Rhizoctonia solani K. Colletotrichum gossypii S. Bacteriostasis rate is 100% for Rhizoctonia solani K. on the 5th day and preparation 3 were superior to preparation 1 (missible oil) and preparation 2 in bacteriostasis effect Preparation 2 also has better effect for Rhizoctonia solani K. and bacteriostasis rate can reach more than 82% on the 5th day. preparation 3 has best effect for inhibiting Colletotrichum gossypii S. and bacteriostasis rate can reach 100% on the 5th day. Preparation 2 is better and preparation 1 has worse effect with less 70% bacteriostasis rate.

Effect of Disease Prevention and Yield Keeping of Tolelofos-Methyl Formulation for Treated Seed

| | | Inhibiting Rhizoctonia | | | | Inhibiting Colletotrichum | | | |
|---|---|---|---|---|---|---|---|---|---|
| | | solani K. | | | | gossypii S. | | | |
| | | the 3rd day | | the 5th day | | the 3rd day | | the 5th day | |
| Preparations | Dilution | Bacteriostasis | p = | Bacteriostasis | p = | Bacteriostasis | p = | Bacteriostasis | p = |
| for experiment | times | rate (%) | 0.05^{a} | rate (%) | 0.05 | rate (%) | 0.05 | rate (%) | 0.05 |
| Prepara- | 10000 | 67.1 | B | 54.5 | C | 76.4 | B | 69.4 | B |
| tion 1 | | | | | | | | | |
| Prepara- | 10000 | 87.2 | B | 82.6 | B | 90.7 | B | 84.6 | B |
| tion 2 | | | | | | | | | |
| Prepara- | 10000 | 100 | A | 100 | A | 100 | A | 100 | A |
| tion 3 | | | | | | | | | |

^{a}p = 0.05 indicates 5% significance difference

### Biological Example 5

### Indoor Virulence Measurement Experiment of 20% FA Hexafumuron for helicoverpAn armigera Hübner

This example was indoor virulence measurement experiment for helicoverpAn armigera Hübner.

Chemical Preparations for Experiment
1, 5% hexafumuron missible oil (available on the market, produced by Dalian Ruize Pesticide Plant)
2, 5% hexafumuron microemulsion
3, 5% FA hexafumuron microemulsion (preparation of this invention in example 3)

Note: The composition and preparation method of chemical preparation 2 and 3 are similar, while the difference is that the former did not contain FA.

Object of Prevention and Cure:

4 years old larva of helicoverpAn armigera Hübner

Experiment Method:

Contact toxicity of above-mentioned chemical preparations was determined using larva immersion method. Larvas were treated by chemical preparations of gradient concentration. Each treatment was repeated 6 times. 48 larvas were investigated each time. Larvas were immersed for 5 seconds, then taken out, and put on the absorbent paper. Unwanted Chemical preparations were absorbed by the paper. Larvas were put into 24 hole test-box respectively and dead rate was surveyed after cultured for 24 hours in constant temperature incubator (to see the following table).

Result of Indoor Virulence Measurement of Hexafumuron Formulation for helicoverpAn armigera Hübner.

| | virulence | | | |
|---|---|---|---|---|
| | regression | LD₅₀(95% | | |
| preparations | equation | confidence limit) | LC₉₀ | synergia |
| for esperiment | (Y=) | (μg/ml) | (μg/ml) | times |
| reparation 1 | 4.9439 + 1.6593x | 1.0086(1.99-0.16) | 10.35 | 1.0 |
| preparation 2 | 2.9708 + 2.2803x | 0.9844(1.77-0.19) | 9.03 | 1.0 |
| reparation 3 | 4.1273 + 2.0689x | 0.2564(0.68-0.15) | 6.027 | 3.93 |

Note:
synergia times = value of LC₅₀ of control preparation/value of LC₅₀ of synergia preparation

### Biological Example 6

### Field Effect of Chemical Preparation Experiment of 5% FA Hexafumuron for helicoverpAn armigera Hübner with Repellency

This example was indoor virulence measurement experiment for helicoverpAn armigera Hübner with repellency.

Chemical Preparations for Experiment
1, 5% hexafumuron missible oil (available on the market, produced by Dalian Ruize Pesticide Plant)
2, 5% hexafumuron microemulsion
3, 5% FA hexafumuron microemulsion (preparation of this invention in example 3)

Note: The composition and preparation method of preparation 2 and 3 are similar, while the difference is that the former does not contain FA.

Object of Prevention and Cure:

HelicoverpAn armigera Hübner.

Experiment Method

The area of each plot is 55 m² with random arrangement and all the treatments are repeated 4 times. Cotton variety for test is general cotton 492 and plant density is 44 thousand/mou. Period of using chemical preparations was major incubation period of second helicoverpAn armigera Hübner. Water consumption was 50 L/mou.

Validity for helicoverpAn armigera Hübner:

It is can be seen from the table, the control effect of three treatments for hexafumuron was not apparent on the 1st day after using chemical preparations. The control effect was up to 63%-67% on the 3rd day after using chemical preparations, but the number of remnant larvas of one hundred in three treatments for hexafumuron was still higher than control target. The control effect went up gradually on the 7th day after using chemical preparations (except preparation 1). The control effect of preparation 3 diluted 1000 times was 91%, which was apparently superior to the effect of preparation 1 and 2 (60% and 78%) treated as preparation 3. Experimental results show that preparation 3 is superior to preparation 1 (missible oil) and preparation 2 in control for helicoverpAn armigera Hübner. Significance test shows that increase of control effect is substantial.

Result of field effect of medicine of hexafumuron formulation for helicoverpAn armigera Hübner

| | | before using | | the 1st day after | | the 3rd day after | | the 7th day after | |
|---|---|---|---|---|---|---|---|---|---|
| | | preparations | | using preparations | | using preparations | | using preparations | |
| | dilution | number | number | Remnant | control | remnant | control | remnant | control |
| preparations | times | of egg | of larva | larva | effect | larva | effect | larva | effect |
| preparation 1 | 1000 | 159 | 77 | 38 | 29 | 53 | 63 | 43 | 60 |
| preparation 2 | 1000 | 149 | 44 | 37 | 8 | 35 | 69 | 19 | 78 |
| preparation 3 | 1000 | 195 | 53 | 34 | 28 | 32 | 79 | 9 | 91 |
| blank | | 144 | 89 | 81 | — | 150 | — | 91 | — |

Chemical injury did not appear within the test concentration. Field experiment shows that control effect of preparation 3 for helicoverpAn armigera Hübner has significant difference from congeneric preparations (preparation 1 and 2).

### Biological Example 7

### Indoor Virulence Measurement of 15% FA Triazophos for chilo suppressalis

This example was indoor virulence measurement experiment for chilo suppressalis.

Preparations for Experiment
1, 20% triazophos missible oil (available on the market, Produced by Hubei province shanlongda Co., Ltd.)
2, 15% triazophos microemulsion
3,15% FA triazophos microemulsion (preparation of this invention in example 4)

Note: The composition and preparation method of chemical preparation 2 and 3 are similar, while the difference is that the former does not contain FA.

Object of Prevention and Cure:

2 years old larva of chilo suppressalis fed by man in room.

Experiment Method

Immersion method was used in this experiment. 2 years old larvas of chilo suppressalis fed indoor were immersed in Chemical preparations of various concentrations using the above-mentioned test preparations. Test larvas were taken out after about 3 seconds and dried in air on the absorbent paper, then it was put in culture dish and fed with artificial feedstuff. The experiment result was observed after 24 hours. Ambient temperature was kept 26±1 deg c. while determining. Lavas were treated with chemical preparation of 5 different concentrations on the base of preliminary experiment, each treatment was repeated 4 times, and 25 larvas were investigated each time. According to the result of 24 hours treatment, co-toxin coefficient of composition was calculated using sun, y-p and JohnsonER (1996) methods. Synergia effect was examined according to the coefficient.

Experimental Result:

According to result of 24 hours experiment for chemical preparations for test of different concentrations, virulence regression equations of various chemical preparation for test were obtained.

Result of Indoor Virulence Measurement of Triazophos Formulation for chilo suppressalis

| | virulence | | | |
|---|---|---|---|---|
| preparations | regression | correlation | LC₅₀ | LC₉₀ |
| for experiment | equation(Y=) | coefficient r | (mg/L) | (mg/L) |
| preparation 1 | Y = 3.7439 + 2.1126X | 0.9646 | 3.647 | 25.92 |
| reparation 2 | Y = 4.0749 + 1.6112X | 0.9934 | 3.611 | 25.46 |
| reparation 3 | Y = 5.4198 + 1.6107X | 0.9967 | 1.078 | 19.64 |

### Biological Example 8

### Field Effect of 15% FA Triazophos Microemulsion for chilo suppressalis

This example was field effect of chemical preparation for chilo suppressalis with repellency.

Chemical Preparations for Experiment
1, 20% triazophos missible oil (available on the market, produced by Zhejiang Xinnong Chemical Industry Co., Ltd.)
2, 15% triazophos microemulsion
3, 15% FA triazophos microemulsion (preparation of this invention in example 4)

Note: The composition and preparation of chemical preparation 2 and 3 are similar, while the difference is that the former did not contain FA.

Object of Prevention and Cure:

first chilo suppressalis, test crop is gold prematurity 47.

Experiment Method

There were 2 treatments in this test, that was to say, preparation 3 was used at 100 ml/mou and 125 ml/mou respectively and 100 ml preparation 1 and 2 were the control. In addition, blank control with spraying water was demanded. The area of test plot was chosen to be 30 m², repeating 4 times with random grouping arrangement. All of the treatments were done in the morning of may 19 using labour-farmer 16 hand sprayer. Quantity of water was applicated with 50 kg/mou. Period of using preparations was major period of 2 years old larva of first chilo suppressalis. The weather was from somber to cloudy on the day of using preparations and average air temperature was 20.7 deg c., It rained on the 5th day after using preparations.

Method of Investigation:

On the 4th day after using preparation, 10 plants with deustate theca were pulled out at random from each plot. The number of dead and live larvas was surveyed and death rate was calculated. Number of plant with dead heart was investigated using 200 parallel sampling from every plot after the damage is maximized (Jun. 9). Finally, the rate of dead heart and effect of seedling protection were calculated. And the condition of rice chemical injury was visually observed time and again after using preparations.

Effect of Prevention and Cure:

Investigation result of first chilo suppressalis after the damage is maximazed shows that the 2 treatments of preparation 3 have exceedingly substaintial effect of seedling protection that has significant difference from preparation 1 and 2. Effect of preparation 3 achieve 96.6%-98.3%. The 2 treatments of preparation 3 have very substantial pesticidal effect on first chilo suppressalis. Death rate of insect mouth can reach 94.6%-98.3% after 3 days, which has significant difference from control preparation 1 and 2.

Result of Field Effcet of Medicine of Triazophos Formulation for chilo suppressalis

| | effect of seedling | | | | |
|---|---|---|---|---|---|
| | protection | | pesticidal effect | | |
| | average | average | average | | |
| preparations for | rate of | effect of | number of | average | effect for |
| experiment and | dead | seedling | killing | number | prevention |
| dosage | heart | protection | larvas | of larvas | and cure |
| preparation 3 | 0.04 aA | 96.6% | 28.0 | 28.8 | 97.4% |
| 125 ml | | | | | |
| preparation 3 | 0.03 aA | 98.3% | 29.3 | 29.8 | 98.3% |
| 100 ml | | | | | |
| preparation 2 | 0.12 bC | 89.3% | 26.0 | 29.0 | 89.6% |
| 100 ml | | | | | |
| preparation 1 | 0.08 bB | 92.8% | 30.3 | 33.2 | 91.3% |
| 100 ml | | | | | |
| CK | 3.58 cC | — | 0 | 27.0 | — |

The result observed visually time and again after using preparations indicates that chemical injury did not appear in treated rice. That shows that Chemical preparation for test are safe to rice under the condition in this test.

### Biological Example 9

### Indoor Virulence Measurement Experiment of 20% FA Carbosulfano Microemulsion for Aphis gossypii Glover

This example was indoor virulence measurement experiment for Aphis gossypii Glover.

Chemical Preparations for Experiment
1, 20% carbosulfano missible oil (available on the market, produced by FMC corp)
2, 20% carbosulfano microemulsion
3, 20% FA carbosulfano microemulsion (preparation of this invention in example 5)

Note: The composition and preparing process of preparation 2 and 3 are similar, while the difference is that the former does not contain FA.

Object of Prevention and Cure:

Aphis gossypii Glover

Chemical preparation film of leaf method was used in this experiment. The leaves of fresh cabbage(cultivated by the inventor) without containing pesticide were immersed in chemical preparations of various concentrations for 10 seconds,. taken out, dried in shade and put in 9 cm plastic culture dish. 25 aphises were put in each dish and each treatment of specific concentration was repeated 3 times. Result of various chemical preparations for test was observed after 24 hours, and the virulence regression equations of various chemical preparation for test were obtained.

Result of indoor virulence measurement of carbosulfano formulation for Aphis gossypii Glover.

| | virulence | | | |
|---|---|---|---|---|
| preparations | regression equation | correlation | LC₅₀ | LC₉₀ |
| for experiment | (Y=) | coefficient r | (mg/L) | (mg/L) |
| preparation 1 | Y = 3.8914 + 2.0164X | 0.9764 | 2.476 | 15.26 |
| preparation 2 | Y = 4.7193 + 1.5915X | 0.9942 | 2.514 | 16.63 |
| preparation 3 | Y = 5.5181 + 1.5174X | 0.9971 | 1.028 | 8.82 |

### Biological Example 10

### Field Effect of 20% FA Carbosulfano Microemulsion for Toxoptera citricidus Kirkaldy

This example was field effect of medicine experiment for Toxoptera citricidus Kirkaldy.

Preparations for Experiment
1, 20% carbosulfano missible oil (available on the market, produced by FMC corp)
2, 20% carbosulfano microemulsion
3, 20% FA carbosulfano microemulsion (preparation of this invention in example 5)

Note: The composition and preparation method of chemical preparation 2 and 3 are similar, while the difference is that the former did not contain FA.

Object for Experiment: is orange crop and Toxoptera citricidus Kirkaldy is the Object of prevention and cure.

Experiment Method

Chemical preparation 3 was set 2 concentrations, which was 3000 times liquid and 1500 times liquid. Chemical preparation 1 and 2 of 1500 times liquid were used as comparison preparations. Blank control with spraying water was demanded and the number of all treatments was 6. The area of test plot was 45 m², serially arranged, repeating 4 times. Guard rows were set between the plots. Chemical preparations were dispersed equably using labour-farmer 16 sprayer in the early occurrence period (July 24) of Aphis gossypii Glover. On the 1 st day before using chemical preparations and 1st, 3rd, 7th day after using preparations, 5 samples were taken out from each test plot. The number of live aphis was surveyed. Decrease rate of insect mouth and the control effect were calculated.

Experimental results show that the control effects of preparation 3 of 1500 and 3000 times liquid were 90.6% and 92.5% respectively on the 1 st day after using preparations, 99.2% and 97.7% on the 3rd day and 98.1% and 93.8% on the 7th day after using preparations.97.79%. The control effects of preparation 3 in various periods are higher than that of preparation 1 and 2. Significant test for control effect after 7 days using preparation shows that the difference is not significant between the two concentrations of preparation 3, but preparation 3 had very significant difference from preparation 1 and 2.

Result of Field Effect of Medicine of Carbosulfano Formulation for Toxoptera citricidus Kirkaldy

| | | | the 1st day after | | the 3rd day after | | the 7th day after | |
|---|---|---|---|---|---|---|---|---|
| | | cardinal | using preparation | | using preparation | | using preparation | |
| preparations for | dilution | number | number | control | number | control | number | control |
| experiment | times | of pest | of pest | effect | of pest | effect | of pest | effect |
| preparation 1 | 1500 | 458.3 | 46.8 | 89.4 | 40.5 | 92.2 | 41.3 | 88.6 |
| preparation 2 | 1500 | 288.2 | 30.4 | 89.3 | 22.1 | 93.1 | 23.4 | 87.9 |
| preparation 3 | 1500 | 650.0 | 54.3 | 90.6 | 8.8 | 99.2 | 7.5 | 98.1 |
| preparation 3 | 3000 | 237.3 | 15.8 | 92.5 | 9.3 | 97.7 | 9.0 | 93.8 |
| blank | — | 320.8 | 286.3 | 0 | 538.3 | 0 | 196.5 | 0 |

Chemical injury did not appear within the test concentration. Field experiment shows that control effect of preparation 3 for Toxoptera citricidus Kirkaldy has significant difference from congeneric preparations (preparation 1 and 2).

### Biological Example 11

### Indoor Virulence Measurement Experiment of 20% FA Thiodan Microemulsion for Aphis pomi Van De Geer

This example was indoor virulence measurement experiment for Aphis pomi Van De Geer.

Preparations for Experiment
1, 20% thiodan missible oil (available on the market, produced by AgrEvo corp.)
2, 20% thiodan microemulsion
3, 20% FA thiodan microemulsion (preparation of this invention in example 6)

Note: The composition and preparation method of chemical preparation 2 and 3 are similar, while the difference is that the former did not contain FA.

Object of Prevention and Cure:

Aphis pomi Van De Geer.

Experiment Method

Chemical preparation film of leaf method was used in this experiment. The leaves of fresh cabbage (cultivated by the inventor) without containing pesticide were immersed in above-mentioned chemical preparations of various concentrations for 10 seconds,. taken out, dried in shade and put in 9 cm plastic culture dish. 50 aphises were put in each dish and each treatment of specific concentration was repeated 3 times. The result was observed after 24 hours, and the value of LC₅₀ was calculated.

Result of Indoor Virulence Measurement of Thiodan Formulation for Aphis pomi Van De Geer.

| | virulence | | | |
|---|---|---|---|---|
| preparations | regression equation | correlation | LC₅₀ | LC₉₀ |
| for experiment | (Y=) | coefficient r | (mg/L) | (mg/L) |
| preparation 1 | Y = 4.8739 + 3.2154X | 0.9867 | 10.17 | 25.92 |
| preparation 2 | Y = 4.9721 + 2.5121X | 0.9928 | 9.41 | 24.64 |
| preparation 3 | Y = 6.1298 + 2.4172X | 0.9971 | 3.91 | 20.44 |

### Biological Example 12

### Field Effect of 20% FA Thiodan Microemulsion for Aphis gossypii Glover

This example was field effect of medicine experiment for Aphis gossypii Glover.

Preparations for Experiment
1, 20% thiodan missible oil (available on the market, produced by AgrEvo corp.)
2, 20% thiodan microemulsion
3, 20% FA thiodan microemulsion (preparation of this invention in example 6)

Note: The composition and preparation method of chemical preparation 2 and 3 are similar, while the difference is that the former does not contain FA.

Object of Prevention and Cure:

Aphis gossypii Glover

Experiment Method: preparation 3 was set to 2000 times liquid. Blank control with spraying water was demanded and treatments was repeated 6 times. The area of each test plot was 30 m², serially arranged, repeating 4 times. Guard rows were set between the plots. Chemical preparations were dispersed equably using labour-farmer 16 sprayer in the early occurrence period (July 24) of Aphis gossypii Glover On the 1st day before using preparations and 1 st, 3rd, 7th day after using preparations, 5 samples were taken out from each test plot. The number of live aphis was surveyed. Decrease rate of insect mouth and the control effect were calculated.

Experimental results show that the control effects of preparation 3 of 2000 times liquid are 99.7% on the 1st day after using preparations, 99.9% on the 3rd day and 97.8% on the 7th day after using preparations. The control effects of preparation 3 in various periods are higher than that of preparation 1 and 2 of 2000 times liquid. Significant difference analyse for control effect after 7 days using preparations indicates that preparation 3 has significant difference from preparation 1 and 2). Result of field effect of medicine of thiodan for Aphis gossypii Glover.

| | | number of | | | |
|---|---|---|---|---|---|
| | | live aphis | correcting control effect of | | |
| preparation | dilution | before using | various days after treated (%) | | |
| name | times (×) | preparations | 1 | 3 | 7 |
| preparation 1 | 2000 | 1250 | 79.8 | 93.0 | 85.9 |
| preparation 2 | 2000 | 1594 | 88.7 | 92.8 | 83.4 |
| preparation 3 | 2000 | 1450 | 99.7 | 99.9 | 97.8 |

Chemical injury did not appear within the test concentration.

### Biological Example 13

### Indoor Virulence Measurement Experiment of 5% FA Fenpyroximate Microemulsion for tetranychus urticae

This example was indoor virulence measurement experiment for Tetranychus urticae.

Chemical Preparations for Experiment
1, 5% fenpyroximate suspending agent (available on the market, produced by Zhejiang province Huangyan Pesticide Plant)
2, 5% fenpyroximate microemulsion
3, 5% FA fenpyroximate microemulsion (preparation of this invention in example 7)

Note: The composition and preparation method of chemical preparation 2 and 3 are similar, while the difference is that the former did not contain FA.

Insect for Experiment

Tetranychus urticae fed in room.

Experiment Method

The cotton seedling with only two cotyledons was infected by tetranychus urticae fed in room for 24 hours. Then, the seedling with tetranychus urticae was immersed in chemical preparation. About 60-70 adult acarids were in a seedling. Each preparation was given 5 concentrations and each specific concentration was repeated 3 times. Blank control with seedling immersed in water was demanded. Treated plants were put in thermostatic container (23±1 deg c.), and the number of dead and live adult acarids was observed after 24 hours. The effect of killing acarids was calculated using biometrical method.

Result of Indoor Virulence Measurement of Fenpyroximate Formulation for Adult Acarid.

| | virulence | | | | | |
|---|---|---|---|---|---|---|
| preparations | regression | LC₅₀ | LC₉₀ | correlation | relative virulence | |
| for experiment | equation(y=) | (ppm) | (ppm) | coefficient r | LC₅₀ | LC₉₀ |
| preparation 1 | 0.5611 + 4.0422x | 11.86 | 39.28 | 0.9771 | 1 | 1 |
| preparation 2 | 2.0633 + 3.5627x | 6.67 | 19.31 | 0.9969 | 1.78 | 1.57 |
| preparation 3 | 2.4512 + 4.1025x | 3.14 | 10.96 | 0.9987 | 3.78 | 3.58 |

### Biologocal Example 14

### Field Effect of 5% FA Fenpyroximate Microemulsion for tetranychus urticae

This example was field effect of medicine experiment for tetranychus urticae.

Chemical Preparations for Experiment
1, 5% fenpyroximate suspending agent (available on the market, produced by Zhejiang province Huangyan Pesticide Plant)
2, 5% fenpyroximate microemulsion
3, 5% FA fenpyroximate microemulsion (preparation of this invention in example 7)

Note: The composition and preparation method of chemical preparation 2 and 3 are similar, while the difference is that the former did not contain FA.

Insect for Experiment

Tetranychus urticae fed in room.

Experiment Method

The eggs layed by adult acarid on the cotyledon of cotton seedling within 24 hours were immersed in the above-mentioned chemical preparations for test of various concentrations, then put in thermostatic container. The incubated egg number was examined after a week. Each treatment of specific concentration was repeated 3 times and effect of killing egg was counted.

Result of Experiment:

Toxic symptom appeared in the adult acarids on cotton seedling treated with chemical preparations quickly, which were slowly crawl speed, losing balance, drop, twitch, rolling, and death.

Effect of Killing Eggs of Fenpyroximate Formulation.

| | Concen- | number of | incu- | rate of |
|---|---|---|---|---|
| preparations | tration | egg for | bating | hatcha- |
| for experiment | (ppm) | experiment | number | bility (%) |
| preparation 1 | 80 | 247 | 0 | 0 |
| | 40 | 204 | 68 | 33.3 |
| | 20 | 235 | 108 | 45.9 |
| preparation 2 | 40 | 215 | 0 | 0 |
| | 20 | 228 | 35 | 15.4 |
| | 10 | 203 | 86 | 42.4 |
| preparation 3 | 8 | 199 | 0 | 0 |
| | 4 | 233 | 5 | 2.1 |
| | 2 | 219 | 9 | 4.1 |
| CK | | 198 | — | 100 |

The results in above-mentioned table show that death rate using preparation 3 is over 90% in 2 ppm and 100% in 8 ppm. Chemical preparation 3 is superior t preparation 1 and 2 in effect.

### Biological Example 15

### Indoor Virulence Measurement Experiment of 20% FAn AbamecetinChlorpfezinEmanectin benzoate Microemulsion for helicoverpAn armigera Hübner

This example was indoor virulence measurement experiment for helicoverpAn armigera Hübner.

Chemical Preparations for Experiment
1, 0.2% AbamecetinChlorpfezinEmanectin benzoate missible oil (available on the market, produced by Shandong Jingbo Agrochemical Co., Ltd.)
2, 0.2% AbamecetinChlorpfezinEmanectin benzoate microemulsion
3, 0.2% FAN in AbamecetinChlorpfezinEmanectin benzoate microemulsion preparation of this invention in example 8)

Note: The composition and preparing process of preparation 2 and 3 are similar, while the difference is that the former does not contain FA.

Experimentation Method

Insect for experiment is helicoverpAn armigera Hübner, 4 years old.

Contact toxicity of above-mentioned chemical preparations was determined using larva immersion method. Larvas were immersed in chemical preparations of various concentrations. Each treatment was repeated 6 times and 48 larvas were surveyed each time. Larvas were immersed for 5 seconds, taken out and put on the absorbent paper. Unwanted liquors were absorbed. larvas were put into 24 hole test-box respectively and dead rate was surveyed after cultured for 48 hours in constant temperature incubator.

Result of Indoor Virulence Measurement of AbamecetinChlorpfezinEmanectin Benzoate Formulation

| preparations | virulence | LD₅₀(95% | | |
|---|---|---|---|---|
| for | regression | confidence limit) | LC₉₀ | synergia |
| experiment | equation (Y=) | (μg/ml) | (μg/ml) | times |
| preparation | 4.9439 + 1.6593x | 1.0086(1.99-0.16) | 10.35 | 1.0 |
| 1 | | | | |
| preparation | 2.9708 + 2.2803x | 0.9844(1.77-0.19) | 9.03 | 1.0 |
| 2 | | | | |
| preparation | 4.1273 + 2.0689x | 0.2564(0.68-0.15) | 6.027 | 3.82 |
| 3 | | | | |

Note:
synergia times = value of LC₅₀ of control preparation/value of LC₅₀ of synergia preparation

### Biological Example 16

### Field Effect of 0.2% FAN AbamecetinChlorpfezinEmanectin Benzoate Microemulsion for helicoverpAn armigera Hübner

This example was field effect of medicine experiment for helicoverpAn armigera Hübner.

Chemical Preparations for Experiment
1, 0.2% abamecetinChlorpfezinEmanectin benzoate missible oil (available on the market, produced by Shandong Jingbo Agrochemical Co., Ltd.)
2, 0.2% AbamecetinChlorpfezinEmanectin benzoate microemulsion,
3, 0.2% FAN AbamecetinChlorpfezinEmanectin benzoate microemulsion (preparation of this invention in example 8)

Note: The composition and preparation method of preparation 2 and 3 are similar, while the difference is that the former does not contain FA.

Condition of Experiment:

Hebei experimental cotton field was chosen for the test. Variety for test was general cotton 492 planted on the end of Apr. In test plot, management practices and growth vigor were consistent and appearance of worm burden was medium. Most larvas were 3-4 years old. The chemical preparations were used 3 times in the whole test period.

Spraying Method

The area of each plot was 50 m², repeating 3 times, The area of each test plot is 25 m² with random grouping arrangement. General spraying was done using KIM-9-MATABI knapsack-type hand sprayer.

Method of Investigation:

Five points sampling method was used in every plot before spraying. The number of all live larvas in 5-10 cottons was investigated and considered as cardinal number of larva. Number of live larvas was surveyed on the 1st and 7th day after using preparations.

Experimental results show that chemical preparation 3 is superior to preparation 1 and preparation 2 in control effect for helicoverpAn armigera Hübner remarkably. Significance test shows that growth of control effect is substantial.

Field effect of AbamecetinChlorpfezinEmanectin benzoate formulation for helicoverpAn armigera Hübner

| | | | the 1st day after | | the 3rd day after | | the 7th day after | |
|---|---|---|---|---|---|---|---|---|
| | | cardinal | using preparation | | using preparation | | using preparation | |
| preparations for | dilution | number | number | control | number | control | number of | control |
| experiment | times | of pest | of pest | effect | of pest | effect | pest | effect |
| preparation 1 | 1500 | 458.3 | 46.8 | 89.4 | 40.5 | 92.2 | 41.3 | 88.6 |
| preparation 2 | 1500 | 288.2 | 30.4 | 89.3 | 22.1 | 93.1 | 23.4 | 87.9 |
| preparation 3 | 1500 | 650.0 | 54.3 | 90.6 | 8.8 | 99.2 | 7.5 | 98.1 |
| preparation 3 | 3000 | 237.3 | 15.8 | 92.5 | 9.3 | 97.7 | 9.0 | 93.8 |
| blank | — | 320.8 | 286.3 | 0 | 538.3 | 0 | 196.5 | 0 |

Chemical injury did not appear within the test concentration. Field experiment shows that control effect of chemical preparation 3 for helicoverpAn armigera Hübner has significant difference from congeneric preparations (preparation 1 and 2).

### Biological Example 17

### Indoor Virulence Measurement Experiment of 2.5% FA Deltamethrin Microemulsion for Cabbage Worm

This example was indoor virulence measurement experiment for cabbage worm.

Chemical Preparations for Experiment
1, 2.5% deltamethrin missible oil (available on the market, produced by Bayer corp.)
2, 2.5% FA deltamethrin microemulsion (preparation of this invention in example 10)
3, 2.5% FA deltamethrin microemulsion* (preparation of this invention in example 10)

Note: The composition of chemical preparation 2 and 3 are the same, while the difference is that the former did not be reprocessed using flow depth ultromicro dispersion.

Larva immersion method was used in this experiment. Chemical preparations for test and control preparations were diluted with water to 6-9 different concentrations

((0.0975 μg/ml, 0.195 μg/ml, 0.39 μg/ml, 0.78 μg/ml, 1.56 μg/ml, 3.125 μg/ml, 6.25 μg/ml, 12.5 μg/ml, 25 μg/ml) and various concentration preparations were all 500 ml. 3 years old cabbage worms were slightly put in the net by tweezer. After closing net mouth, the larvas were immersed in above-mentioned preparations and shaked for 5 secons, taken out, and put on the absorbent paper. Unwanted Chemical preparations were absorbed. Larvas were put into 12 cm culture dish respectively. 1 fresh clean cabbage leaf was joined in every dish. Preservative films were demanded and then tightened with rubber band. The results were observed after cultured for 24 and 48 hours in constant temperature incubator. 30 larvas were determined in each concentration, and control liquid was clean water. Death criterion for test larva is that touching larva with needle and having no response completely was considered as dead. The value of LC₅₀,LC₉₀ and 95% confidence limit of microemulsion and missible oil were calculated by computer.

Result of Experiment:

Results determined by larva immersion method for cabbage worm are showed in the following table. After 24 hours treatment, the value of LC₅₀ of preparation 1 (missible oil) is 1.3695 μg/ml,. the values of LC₅₀ of preparation 2 and 3 (microemulsion) are 0.4324 μg/ml and 0.4161 μg/ml, and virulence was improved by 3.1 and 3.3 times respectively. After 48 hours treatment, the values of LC₅₀ of preparation 2 and 3 (microemulsion) are 0.2812 μg/ml and 0.2742 μg/ml, and virulence was improved by 4.0 and 4.2 times respectively compared to the value of LC₅₀ (1.1498 μg/ml) of preparation 1. In addition, value of LC₅₀ and 95% confidence limit of preparation 2 and 3 did not overlap with that of preparation 1. This indicates that the virulence of microemulsion for cabbage worm is improved remarkably compared to missible oil.

Result of Indoor Virulence Measurement of Deltamethrin Formulation for Cabbage Worm.

| | | virulence | LC₅₀ | LD₅₀(95% | LC₉₀ | |
|---|---|---|---|---|---|---|
| | testing | regression | (μg/ml) | confidence | (μg/ml) | virulence |
| Preparation | time | equation (Y=) | ppm | limit) | ppm | times |
| Preparation 3 | 24 hours, | 5.4027 + 1.0575X | 0.4161 | 0.2266-0.7643 | 6.8023 | 3.3 |
| Preparation 2 | | 5.3215 + 1.0247X | 0.4324 | 0.2352-0.7125 | 6.9275 | 3.1 |
| Preparation 1 | | 4.7905 + 1.5346X | 1.3695 | 0.8063-2.3260 | 9.3627 | 1.0 |
| Preparation 3 | 48 hours, | 5.6234 + 1.1093X | 0.2742 | 0.1308-0.5748 | 3.9333 | 4.2 |
| Preparation 2 | | 5.5716 + 1.1083X | 0.2812 | 0.1624-0.6013 | 3.8954 | 4.0 |
| Preparation 1 | | 4.9031 + 1.5978X | 1.1498 | 0.6801-1.9441 | 7.3077 | 1.0 |

### Biological Example 18

### Field Effect of 2.5% FA Deltamethrin Microemulsion for helicoverpAn armigera Hübner

This example was field effect of medicine experiment for helicoverpAn armigera Hübner.

Condition of Experiment:

Hebei experimental cotton field was chosen for the experimental. Cotton variety for test was general cotton 492 planted on the end of Apr. In test plot, management practices and growth vigor were consistent and appearance of worm burden was medium. Most larvas are 3-4 years old. The chemical preparations were used 2 times in the whole test period.

Chemical Preparations for Experiment
1, 2.5% deltamethrin missible oil (available on the market, produced by Bayer corp.)
2, 2.5% FA deltamethrin microemulsion (preparation of this invention in example 10)
3, 2.5% FA deltamethrin microemulsion* (preparation of this invention in example 10)

Note: The composition of chemical preparation 2 and 3 are the same, while the difference is that the former did not be reprocessed using flow depth ultromicro dispersion.

Spraying Method

Each of the five above-mentioned treatments was repeated 2 times. The area of test plot was 15 m² with random grouping arrangement. General spraying was done using KIM-9-MATABI knapsack-type hand sprayer.

Method of Investigation:

Five points sampling method was used in every plot before spraying. The number of all live larvas in 5-10 cotton was investigated and considered as cardinal number of larva. The number of live larvas was surveyed on the 1 st and 7th day after using preparations.

Experimental results show that preparation 2 and 3 (microemulaion) is superior to preparation 1(missible oil) in control effect for helicoverpAn armigera Hübner. Significance test shows that growth of control effect is substantial. Moreover, preparation 2 has significant difference from preparation 3. Results are described in detail in the following table.

Result of Field Effect of Medicine of Deltamethrin Formulation for helicoverpAn armigera Hübner

| | | | the 1st day after using | | | the 7th day after using | | |
|---|---|---|---|---|---|---|---|---|
| | | number of | preparations | | | preparations | | |
| Preparations for | | live larva | number | | control | number | | control |
| experiment and | | before using | of live | rate of | effect | of live | rate of | effect |
| concentration | repeatition | preparations | larva | decrease (%) | correction | larva | decrease (%) | correction |
| Preparation 3 | 1 | 53 | 1 | 98 | 98a | 0 | 100 | 99a |
| 1500× | 2 | 52 | 1 | 98 | | 1 | 98 | |
| Preparation 2 | 1 | 50 | 3 | 94 | 96a | 2 | 96 | 97b |
| 1500× | 2 | 51 | 1 | 98 | | 1 | 98 | |
| Preparation 1 | 1 | 52 | 3 | 94 | 95a | 3 | 94 | 95b |
| 1500× | 2 | 51 | 2 | 96 | | 2 | 96 | |
| Preparation 3 | 1 | 51 | 3 | 94 | 94a | 3 | 94 | 94b |
| 3000× | 2 | 54 | 3 | 94 | | 3 | 94 | |
| Preparation 2 | 1 | 50 | 5 | 90 | 91b | 6 | 88.2 | 89c |
| 3000× | 2 | 51 | 4 | 92 | | 5 | 90 | |
| Preparation 1 | 1 | 50 | 10 | 80 | 81c | 10 | 80 | 80d |
| 3000× | 2 | 50 | 9 | 82 | | 10 | 80 | |
| CK | 1 | 30 | 30 | | | 30 | 0 | |
| | 2 | 31 | 31 | | | 30 | 0 | |

Test time: Jul. 8-15, 2003, English letters following the numbers in the table are different that indicates significant difference (P=0.05,HSD).HSD)

Chemical injury did not appear within the test concentration. Field experiment shows that control effect of microemulsion of this invention for helicoverpAn armigera Hübner has significant difference from congeneric preparations.

### Biological Example 19

### Indoor Virulence Measurement Experiment of 2.5% FA Imidacloprid Microemulsion for Lipaphis erysimi pseudo-brassicae

This example was indoor virulence measurement experiment for Lipaphis erysimi pseudo-brassicae.

Chemical Preparations for Experiment
1, 5% imidacloprid missible oil (available on the market, produced by Bayer corp.)
2, 5% FA imidacloprid microemulsion (preparation of this invention in example 11)
3, 5% FA imidacloprid microemulsion* (preparation of this invention in example 11)

Note: The composition of preparation 2 and 3 are the same, while the difference is that the former did not be reprocessed using flow depth ultromicro dispersion.

The above-mentioned 3 preparations were diluted with water to 5 concentrations on the basis of preliminary experiment. Death rate of test insects was between 10% and 90% caused at the selected concentration range. Then, indoor virulence measurement was conducted using leaf immersion method recommended by FAO. That was to say, radish leaves with high density of insect mouth were selected, and other insects and impurity were removed with brush pen under stereoscopy binocular microscope. 50-70 apterous aphises with the body of the similar size were kept in every leaf. Then, the larvas were all immersed in above-mentioned preparations for 5 seconds. Unwanted Chemical preparations were absorbed with filter paper. The aphises were put in culture dish and each treatment of specific concentration was repeated 3 times. In addition, blank control with clean water was demanded, and then the culture dish was put in incubator of 28±1 deg c. Death result of aphises was examined under stereoscopy binocular microscope after 48 hours and death rate was corrected with Abbott formula. Virulence regression equation of various chemical preparation for test and semi-lethal concentration LC₅₀ were obtained according to concentration logarithm—Bliss method.

Result of Indoor Virulence Measurement of Imidacloprid Formulation for Lipaphis erysimi pseudo-brassicae.

| | virulence | | | viru- |
|---|---|---|---|---|
| | regression | LC₅₀ | correlation | lence |
| preparation | equation (Y=) | (μg/ml)ppm | coefficient r | times |
| preparation 3 | 2.1350 + 5.4558 x | 2.1661 | 0.9238 | 3.4 |
| preparation 2 | 2.6028 + 2.7382 x | 2.4014 | 0.9574 | 3.1 |
| preparation 1 | 2.2835 + 4.4703 x | 7.3958 | 0.9423 | 1.0 |

### Biological Example 20

### Field Effect of 20% FA Imidacloprid Microemulsion for Lipaphis erysimi pseudo-brassicae

This example was field effect of medicine experiment for Lipaphis erysimi pseudo-brassicae.

Chemical Preparations for Experiment
1, 5% imidacloprid missible oil (available on the market, produced by AgrEvo corp.)
2, 5% FA imidacloprid microemulsion (preparation of this invention in example 11)
3, 5% FA imidacloprid microemulsion (preparation of this invention in example 11)

Note: The composition of chemical preparation 2 and 3 are the same, while the difference is that the former did not be reprocessed using flow depth ultramicro dispersion.

Object of Prevention and Cure:

Lipaphis erysimi pseudo-brassicae

Experiment Method

The above-mentioned chemical preparations were set to 2000 times liquid. Blank control with spraying water was demanded and the treatment was repeated 6 times. The area of each plot was 30 m², serially arranged, repeating 4 times. Guard rows were set between the plots. Chemical preparations were dispersed equably using labour-farmer 16 sprayer in the early occurrence period of Lipaphis erysimi pseudo-brassicae. On the 1st day before using preparations and 1 st, 3rd, 7th day after using preparations, 5 samples were taken out from each test plot. The number of live aphis was surveyed. Decrease rate of insect mouth and the control effect were calculated.

Experimental results show that the control effect of preparation 3 of 3000 times liquid for Lipaphis erysimi pseudo-brassicae is 92.54% on the 1st day after using preparations, and is 96.74% on the 3rd day and 97.56% on the 7th day after using preparations. The control effects of preparation 3 in various periods are higher than that of preparation 1 and 2 of 2000 times liquid. Significance test for control effect after 7 days using preparations indicates that preparation 2 and 3 have significant difference from preparation 1 (missible oil).

Results of Field Effect of Imidacloprid Microemulsion for Lipaphis erysimi pseudo-brassicae.

| | | number of live | | | |
|---|---|---|---|---|---|
| | | aphis before | correcting control effect of | | |
| preparation | dilution | using | various days after treated (%) | | |
| name | times (×) | preparations | 1 | 3 | 7 |
| preparation 1 | 2000 | 1250 | 80.55 | 85.84 | 85.9 |
| preparation 2 | 2000 | 1594 | 91.32 | 93.79 | 95.21 |
| preparation 3 | 2000 | 1450 | 92.54 | 96.74 | 97.56 |

Chemical injury did not appear within the test concentration.

### Biological Example 21

### Control Test of the Mixture of Fluvic Acid and Triazolone for bipolaris sorokininan

1, Indoor Virulence Measurement

Poison bearing medium method was used to determine the activity of mixture for bipolaris sorokininan in room, and the composition contained preparation 1 (2% FAn aqueous solution), preparation 2 (20% triazolone missible oil) and preparation 3 (18% triazolone+2% FA microemulsion). 45 ml PSA culture medium was put into 100 ml delta-bottle, cooled to 45˜−50 deg c. after sterilization, and 5 ml various preparations for test were added according to preconcerted dosage. Then, said samples were poured to 3 culture dishes of 9 cm diameter after shaking up. The plates containing preparations with various concentrations were prepared. Sterilized water served as control. Lawn with 5 mm diameter was obtained from the edge of bacteria colony cultured for 7 days and inoculated in petri dish, facing downwards. Each preparation was set 5 concentrations and each treatment was repeated 3 times. The lawn was cultured for 4 days at constant temperature of 24 deg c. Colony diameter was determined using cross-scoring method. Numerical value of EC₅₀ was calculated to get virulence regression equation and bacteriostasis activity of chemical preparations was evaluated. Result of indoor virulence measurement experiment shows that FA possesses no bacteriostasis effect for bipolaris sorokininan and triazolone possesses better effect under the condition of in vitro in room.

Result of Indoor Virulence Measurement of Various Preparations for bipolaris sorokininan.

| | | correlation | |
|---|---|---|---|
| | virulence regression | coefficient | EC₅₀ |
| preparation name | straight-line equation, | and significance | (mg/L) |
| preparation 1 | — | — | — |
| preparation 2 | P = 2.1749 + 1.1126X | 0.9581** | 3.461 |
| preparation 3 | P = 3.0619 + 1.2107X | 0.9764** | 0.3988 |

Note:
**indicates exceedingly significant

Result of mixture of FAn and triazolone shows that FA can increase the bacteriostasis effect of triazolone for bipolaris sorokininan remarkably and bacteriostasis effect can be improved with the increase of FA content.

2, Seed Treatment Result:

Seeds treaed with FA whose weight amount to 0.2% seed by weight have disease prevention effect for bipolaris sorokininan and yield keeping effect. After the seeds were treated, the wheat developed well and occurrence of powdery mildew was less compared to blank. Yield keeping effect of mixture of FAn and triazolone was improved from 7.79% of single use of triazolone to 10.67%.

Effect of Disease Prevention and Yield Keeping of Various Preparations for Treated Seeds

| | seedling stage | | ripe plant stage | | | | |
|---|---|---|---|---|---|---|---|
| | | control | attack | | control | | yield |
| preparation | attack | effect | rate | disease | effect | yield | keeping |
| and dosage | rate (%) | (%) | (%) | index | (%) | kg/hm² | effect (%) |
| preparation 1 | 10.8 | 14.29 | 81.3 | 32.9 | 3.80 | 5915.55 | 4.66 |
| preparation 2 | 4.9 | 61.11 | 74.5 | 21.6 | 36.84 | 6246.45 | 7.79 |
| preparation 3 | 4.3 | 65.87 | 69.4 | 18.2 | 46.78 | 6412.80 | 10.67 |
| CK | 12.6 | — | 85.9 | 34.2 | — | 5795.25 | — |

Note:
preparation 1 is 0.2% FA solution
preparation 2 is 0.015% triazolone missible oil diluent
preparation 3 is 0.2% FA + 0.015% triazolone missible oil diluent

The seeds are treated with triazolone. The growth of wheat root was promoted, and the growth of burgeon was suppressed. Root/shoot ratio was improved. The time of seedling emergence was late and the rate of seedling emergence decreased. Theory of the inhibiting effect of triazolone may be that the synthesis of gibberellin in seed is suppressed directly and activity of α-amylase is suppressed indirectly. So speed of germination and seedling is affected.

That only fulvic acid was used on the culture medium possesses no inhibiting effect for bipolaris sorokininan. Fulvic acid mixed with bactericide has substantial synergistic action both in room and in field. The seeds were mixed with 0.2% FA that could improve rate of germination and seedling, reduce the time of seedling, make the plant health and leaves green, decrease disease index of bipolaris sorokininan, have apparent disease prevention and yield keeping effect. Mixture of FAn and triazolone compensates the disadvantage of triazolone which has inhibited the germination and seedling of wheat. This research confirms synergistic action of the mixture of fluvic acid and triazolone for bipolaris sorokininan.

While the invention has been described with generel explanation and embodiments in detail in above-mentioned paragraphs. Based on this invention, the skilled in the art can modify and improve this invention. Therefore, the modifications and improvements without departing from the spirit of the invention belong to the protective scope of this invention.

1. An agricultural chemical microemulsion, comprising agricultural active ingredients and one or more natural high macromolecule material as efficient synergist and/or toxicity antagon selected from the group consisting of: fulvic acid, humic acid, chitosan and dextran.

2. The microemulsion according to claim 1, wherein the weight ratio of natural high macromolecule materials and agricultural active ingredient is 1:0.001-100.

3. The microemulsion according to claim 2, wherein said natural high macromolecule materials are fulvic acid and humic acid.

4. The microemulsion according to claim 1, wherein said agricultural active ingredients are selected from the group consisting of organochlorine insecticide, synthetic pyrethroid insecticide, carbamate insecticide and the like, organic phosphorus insecticide, nereis toxicity insecticide, Abamectin, Abamecetinchlorpfezin Emanectin and its salt, Hexaflumuron, fenpyroximate, imidacloprid, organic phosphorus bactericide, and 1,2,4-triazole bactericide.

5. The microemulsion according to claim 1, wherein said agricultural active ingredients are selected from the group consisting of thiodan, Lambda-cyhalothrin, Decamethrin K-othrin Decis Deltamethrin, triazophosl, carbosulfano, Abamectin, AbamecetinchlorpfezinEmanectin and its salt, Hexaflumuron, fenpyroximate, imidacloprid, tolelofos-methyl and triazolone.

6. The microemulsion according to claim 1, wherein weight percentage of said ingredients are as follows:

| | |
|---|---|
| agricultural active ingredient | 0.1-30% |
| fulvic acid | 0.1-10% |
| cosolvent | 1-10% |
| emulsifier | 5-20% |
| water | the rest. |

7. The microemulsion according to claim 6, wherein the microemulsion further comprises stabilizer and weight percentage of ingredients are as follows:

| | |
|---|---|
| agricultural active compound | 0.1-30% |
| fulvic acid | 0.1-10% |
| cosolvent | 1-10% |
| emulsifier | 5-20% |
| stablizer | 5-10% |
| water | the rest. |

8. The microemulsion according to claim 1, wherein the weight ratio of agricultural active ingredients and fulvic acid is 1:0.1-50.

9. An agricultural chemical microemulsion preparation method, comprising the following steps: dissolving agricultural active ingredients in cosolvent, then adding other processing assistant ingredients, stirring the resulting mixture fully uniformity, then pouring the solution into homogenizer containing dispersion medium water and one or more macromolecule selected from the group consisting of fulvic acid, humic acid, chitosan and dextran, then stirring the solution to uniformity.

10. The microemulsion preparation method according to claim 9, further comprising the step of, processing the mixture using flow depth ultramicro dispersion method.

11. Use of fulvic acid in preparation of agricultural chemical microemulsion according to claim 1.

12. The microemulsion according to claim 2, wherein said agricultural active ingredients are selected from the group consisting of organochlorine insecticide, synthetic pyrethroid insecticide, carbamate insecticide and the like, organic phosphorus insecticide, nereis toxicity insecticide, Abamectin, Abamecetinchlorpfezin Emanectin and its salt, Hexaflumuron, fenpyroximate, imidacloprid, organic phosphorus bactericide, and 1,2,4-triazole bactericide.

13. The microemulsion according to claim 3, wherein said agricultural active ingredients are selected from from the group consisting of organochlorine insecticide, synthetic pyrethroid insecticide, carbamate insecticide and the like, organic phosphorus insecticide, nereis toxicity insecticide, Abamectin, Abamecetinchlorpfezin Emanectin and its salt, Hexaflumuron, fenpyroximate, imidacloprid, organic phosphorus bactericide, and 1,2,4-triazole bactericide.

14. The microemulsion according to claim 2, wherein weight percentage of said ingredients are as follows:

| | |
|---|---|
| agricultural active ingredient | 0.1-30% |
| fulvic acid | 0.1-10% |
| cosolvent | 1-10% |
| emulsifier | 5-20% |
| water | the rest. |

15. The microemulsion according to claim 4, wherein weight percentage of said ingredients are as follows:

| | |
|---|---|
| agricultural active ingredient | 0.1-30% |
| fulvic acid | 0.1-10% |
| cosolvent | 1-10% |
| emulsifier | 5-20% |
| water | the rest. |

16. The microemulsion according to claim 5, wherein weight percentage of said ingredients are as follows:

| | |
|---|---|
| agricultural active ingredient | 0.1-30% |
| fulvic acid | 0.1-10% |
| cosolvent | 1-10% |
| emulsifier | 5-20% |
| water | the rest. |

17. The microemulsion according to claim 3, wherein the weight ratio of agricultural active ingredients and fulvic acid is 1:0.1-50.

18. The microemulsion according to claim 4, wherein the weight ratio of agricultural active ingredients and fulvic acid is 1:0.1-50.

19. The microemulsion according to claim 6, wherein the weight ratio of agricultural active ingredients and fulvic acid is 1:0.1-50.

20. The microemulsion according to claim 7, wherein the weight ratio of agricultural active ingredients and fulvic acid is 1:0.1-50.
